(19) United States
(12) Patent Application Publication
(10) Pub. No.: US 2026/0303988 A1
(43) Pub. Date: Oct. 1, 2026

(54) LIGHT DETECTION DEVICE, LIGHT DETECTION METHOD, AND PROGRAM

(71) Applicant: SONY SEMICONDUCTOR SOLUTIONS CORPORATION, KANAGAWA (JP)

(72) Inventors: HIROSHI KINUGAWA, KANAGAWA (JP); KOJI MATSUURA, KANAGAWA (JP); YUKI NISHINA, KANAGAWA (JP)

(21) Appl. No.: 19/480,245

(22) PCT Filed: Apr. 22, 2024
(86) PCT No.: PCT/JP2024/015731

§ 371 Date: Oct. 30, 2025

(30) Foreign Application Priority Data
May 12, 2023 (JP) 2023-079115

(51) Int. Cl. H04N 25/47; H04N 25/707

(52) U.S. Cl. CPC H04N 25/47; H04N 25/707

(57) ABSTRACT

The present disclosure relates to a light detection device, a light detection method, and a program that can reduce latency caused by an event signal detection sensor. The present disclosure calculates, on the basis of a gradation signal detected by a CMOS image sensor provided in a vicinity of an event signal detection sensor configured to output event data representing occurrence of an event that is a change in an electric signal, the event being detected in an event detection pixel configured to generate the electric signal by performing photoelectric conversion, a plurality of the event detection pixels being disposed on a two-dimensional plane, a received light amount of the event detection pixel, and corrects, on the basis of the received light amount of the event detection pixel, information related to latency in the event data. The present disclosure can be applied to a hybrid EVS sensor.

### TECHNICAL FIELD

The present disclosure relates to a light detection device, a light detection method, and a program, and particularly relates to a light detection device, a light detection method, and a program that can reduce latency caused by an event signal detection sensor.

### BACKGROUND ART

An event signal detection sensor has been proposed that detects an event from a comparison result between a change in an amount of light received by a pixel per unit time and a predetermined threshold, and outputs the event as event data (refer to PTL 1).

### CITATION LIST

### Patent Literature

PTL 1: JP 2020-136958 A

### SUMMARY

### Technical Problem

It is known that in an event signal detection sensor, so-called latency occurs in which an occurrence time of an event that is recorded in extracted event data is delayed relative to an actual event occurrence time due to “transfer rate restrictions” or “circuit response delays that depend on an amount of light received by a pixel per unit time”.

Among these latencies, the latency caused by transfer rate restrictions can be reduced by decreasing the amount of data to be transferred itself, but the reality is that the other latency cannot be reduced.

The present disclosure has been made in view of such circumstances, and, in particular, reduces the latency of an event signal detection sensor.

### Solution to Problem

A light detection device and a program according to an aspect of the present disclosure are a light detection device and a program including an event detecting section configured to output event data representing occurrence of an event that is a change in an electric signal, the event being detected in an event detection pixel configured to generate the electric signal by performing photoelectric conversion, a plurality of the event detection pixels being disposed on a two-dimensional plane; a received light amount calculation section configured to calculate a received light amount of the event detection pixel; and a latency correction section configured to correct information related to latency in the event data on the basis of the received light amount of the event detection pixel calculated by the received light amount calculation section.

A light detection method according to an aspect of the present disclosure is a light detection method including outputting event data representing occurrence of an event that is a change in an electric signal, the event being detected in an event detection pixel configured to generate the electric signal by performing photoelectric conversion, a plurality of the event detection pixels being disposed on a two-dimensional plane; calculating a received light amount of the event detection pixel; and correcting information related to latency in the event data on the basis of the calculated received light amount of the event detection pixel.

In an aspect of the present disclosure, event data representing occurrence of an event that is a change in an electric signal, the event being detected in an event detection pixel configured to generate the electric signal by performing photoelectric conversion, a plurality of the event detection pixels being disposed on a two-dimensional plane, is output, a received light amount of the event detection pixel is calculated, and information related to latency in the event data is corrected on the basis of the calculated received light amount of the event detection pixel.

### BRIEF DESCRIPTION OF DRAWINGS

FIG. 1 is a diagram for describing a configuration example of a signal processing device including an event signal detection sensor.

FIG. 2 is a diagram for describing a configuration example of a pixel circuit of the event signal detection sensor in FIG. 1.

FIG. 3 is a diagram for describing detection of an event.

FIG. 4 is a diagram for describing the principle of latency occurrence.

FIG. 5 is a diagram for describing latency that changes in accordance with a received light amount.

FIG. 6 is a diagram for describing a comparison between latency in an image having a large received light amount and latency in an image having a small received light amount.

FIG. 7 is a diagram for describing a configuration example of a signal processing device according to a first embodiment of the present disclosure.

FIG. 8 is a diagram for describing a positional relationship between a visible light sensor and an optical axis of a lens in a preceding stage of the event signal detection sensor.

FIG. 9 is a diagram for describing a table of the received light amount and the corresponding latency.

FIG. 10 is a flowchart for describing signal processing by the signal processing device in FIG. 7.

FIG. 11 is a diagram for describing a configuration example of a signal processing device according to a second embodiment of the present disclosure.

FIG. 12 is a diagram for describing a positional relationship between optical axes of a condenser lens in a preceding stage of a CMOS image sensor and a condenser lens in a preceding stage of the event signal detection sensor.

FIG. 13 is a diagram for describing an example of applying a received light amount of the CMOS image sensor to a received light amount of a corresponding pixel on the event signal detection sensor.

FIG. 14 is a diagram for describing an example of estimating a spectrum by a ratio of received light amounts of RGB pixels of the CMOS image sensor.

FIG. 15 is a diagram for describing original event data and event data with a time stamp, which is time information, corrected in accordance with a latency correction amount.

FIG. 16 is a diagram for describing original event data and event data obtained by adding time information corrected according to the latency correction amount.

FIG. 17 is a flowchart for describing signal processing by the signal processing device in FIG. 11.

FIG. 18 is a diagram for describing original event data and event data obtained by adding information about the received light amount.

FIG. 19 is a diagram for describing a configuration example of a signal processing device according to a third embodiment of the present disclosure.

FIG. 20 is a flowchart for describing signal processing by the signal processing device in FIG. 19.

FIG. 21 is a diagram for describing a CMOS image sensor and a hybrid EVS sensor.

FIG. 22 is a diagram for describing a relationship between the hybrid EVS sensor and an optical axis of a condenser lens.

FIG. 23 is a diagram for describing a first configuration example of a signal processing device that uses a hybrid EVS sensor according to a fourth embodiment of the present disclosure.

FIG. 24 is a diagram for describing a second configuration example of a signal processing device that uses the hybrid EVS sensor according to the fourth embodiment of the present disclosure.

FIG. 25 is a diagram for describing a third configuration example of a signal processing device that uses the hybrid EVS sensor according to the fourth embodiment of the present disclosure.

FIG. 26 is a diagram for describing a configuration example of a signal processing device according to a fifth embodiment of the present disclosure.

FIG. 27 is a diagram for describing an example of shifting an event data group according to latency in an application example of the present disclosure.

FIG. 28 is a flowchart for describing signal processing realizing a modification of the present disclosure.

FIG. 29 is a diagram for describing a first modification of the example of shifting the event data group according to the latency.

FIG. 30 is a diagram for describing a second modification of the example of shifting the event data group according to the latency.

FIG. 31 is a block diagram depicting an example of a schematic configuration of a vehicle control system.

FIG. 32 is an explanatory view depicting an example of an installation position of an outside-vehicle information detecting unit and an imaging section.

### DESCRIPTION OF EMBODIMENTS

Hereinafter, preferred embodiments of the present disclosure will be described in detail with reference to the accompanying drawings. Note that, in the present specification and the drawings, constituent elements having substantially the same functional configuration are denoted by the same reference signs, and redundant description thereof will be omitted.

Hereinafter, modes for carrying out the present technology will be described. Description will be made in the following order.
1. Overview of Present Disclosure
2. First Embodiment
3. Second Embodiment
4. Third Embodiment
5. Fourth Embodiment
6. Fifth Embodiment
7. Application Example
8. Application Example to Mobile Body

### 1. Overview of Present Disclosure

### Event Signal Detection Sensor

The present disclosure, in particular, reduces latency in an event signal detection sensor.

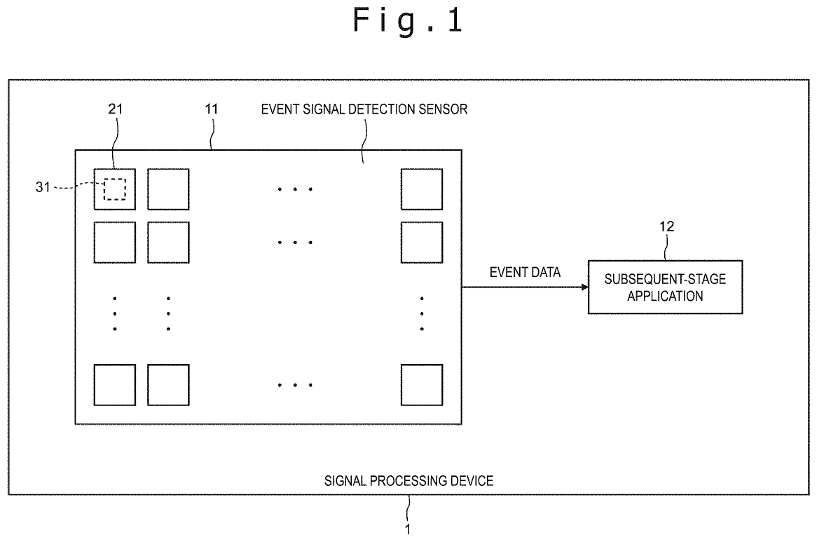

First, the event signal detection sensor will be described. FIG. 1 is a diagram depicting a configuration example of a signal processing device including an event signal detection sensor.

A signal processing device 1 in FIG. 1 includes an event signal detection sensor 11 and a subsequent-stage application 12.

The event signal detection sensor 11 is composed of a so-called pixel array in which a plurality of pixel circuits 21, each including a pixel 31 that photoelectrically converts incident light to generate an electric signal, are disposed in a lattice shape on a two-dimensional plane. The event signal detection sensor 11 generates, in the pixel 31, the electric signal by photoelectrically converting incident light, generates event data indicating occurrence of an event that is a change in the electric signal, and outputs the event data to the subsequent-stage application 12.

The subsequent-stage application 12 is an application program that executes various types of processing on the basis of the event data supplied from the event signal detection sensor 11.

Here, in the event signal detection sensor 11, a portion in which the plurality of pixel circuits 21 are disposed is, as a whole, a portion that receives incident light and performs photoelectric conversion, and thus is also referred to as a light-receiving section.

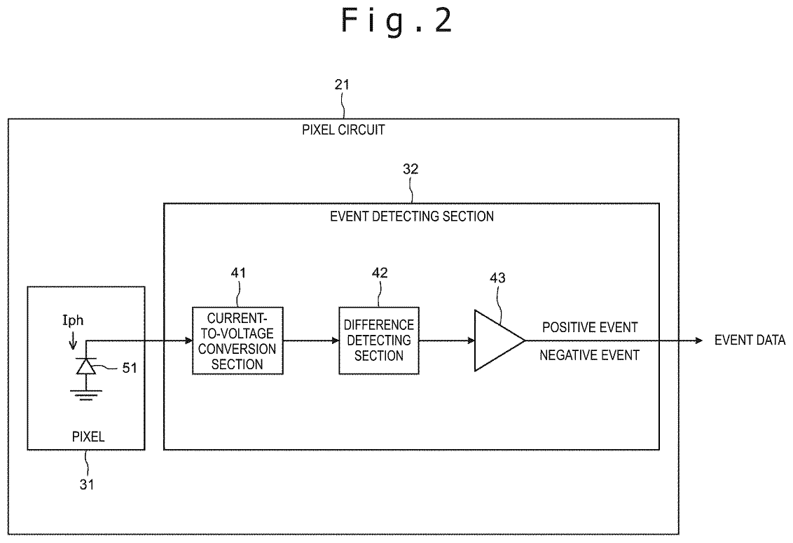

Configuration Example of Pixel Circuit FIG. 2 is a block diagram depicting a configuration example of the pixel circuit 21 in FIG. 1.

The pixel circuit 21 is constituted of the pixel 31 and an event detecting section 32.

The pixel 31 includes a photodiode (PD) 51 as a photoelectric conversion element. The pixel 31, in the PD 51, receives light incident on the PD 51, performs photoelectric conversion, and generates and produces a flow of a photocurrent (Iph) as an electric signal.

In a case in which a change exceeding a predetermined threshold (including a change equal to or greater than the threshold, as necessary) occurs in the photocurrent generated by the photoelectric conversion of the pixel 31, the event detecting section 32 detects the change in the photocurrent as an event. The event detecting section 32 outputs event data in response to (detection of) the event.

Here, a change in the photocurrent generated in the pixel 31 can be regarded as a light amount change in the light incident on the pixel 31, and thus the event can be regarded as a light amount change in the pixel 31 (light amount change exceeding the threshold).

In the event data, at least position information (coordinates or the like) indicating a position of the pixel 31 (pixel circuit 21) in which a light amount change occurred as the event can be specified. In addition, the event data includes information identifying a positive event and a negative event in accordance with a polarity (positive or negative) of the light amount change.

For a series of event data output by the event detecting section 32 at the timing of event detection, time information representing a (relative) time at which the event occurred can be specified as long as an interval between the event data at the time of event occurrence is maintained as is. However, when the interval between the event data at the time of event occurrence is not maintained as it is due to the event data being stored in memory or the like, the time information is lost. Therefore, with regard to the event data, time information indicating a (relative) time at which the event occurred, such as a time stamp, is added to the event data before the interval between the event data at the time of event occurrence is no longer maintained as is. The processing of adding the time information to the event data may be performed by the event detecting section 32 or may be performed outside of the event detecting section 32 as long as before the interval between the event data at the time of event occurrence is no longer maintained as is.

The event detecting section 32 includes a current-to-voltage conversion section 41, a difference detecting section 42, and a comparator 43.

The current-to-voltage conversion section 41 converts the photocurrent from the pixel 31 into a voltage (hereinafter also referred to as photovoltage) Vo corresponding to a logarithm of the photocurrent, and outputs the photovoltage Vo to the difference detecting section 42.

The difference detecting section 42 calculates, for the photovoltage Vo from the current-to-voltage conversion section 41, a difference between a current photovoltage and a photovoltage at a timing different from the current timing by a very brief time, and outputs a difference signal Vout thereof to the comparator 43.

The comparator 43 compares the difference signal Vout output from the difference detecting section 42 and predetermined thresholds (voltages) +Vth and −Vth used for event detection. In a case in which the difference signal Vout is equal to or greater than the threshold +Vth or equal to or less than the threshold-Vth, the comparator 43 determines that a light amount change as an event was detected (occurred), and outputs event data.

For example, in a case in which the difference signal Vout is equal to or greater than the threshold +Vth, the comparator 43 determines that an event having positive polarity was detected and outputs event data having a positive event. On the other hand, in a case in which the difference signal Vout is equal to or less than the threshold −Vth, the comparator 43 determines that a negative event was detected and outputs event data having a negative event.

### Latency of Event Signal Detection Sensor

The event signal detection sensor 11, as described above, detects a change in the amount of light received by the pixel 31 as an event, and outputs, as event data, the coordinates of the pixel at that time, the time, and information indicating a positive event or a negative event.

In a case in which the event signal detection sensor 11 outputs the event data, when latency occurs with respect to the timing at which the event actually occurred, a delay occurs in the timing at which the event is detected, and the time information about the event data results in a time delayed from the time at which the event actually occurred.

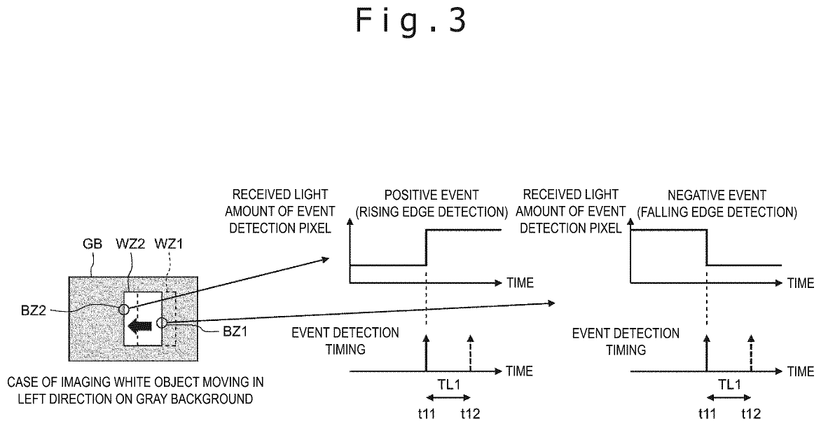

For example, as depicted in the left portion in FIG. 3, a case is considered in which a region where a white object exists on a gray background moves from a region WZ1 indicated by a dotted line to a region WZ2 in a left direction as indicated by an arrow.

In this case, at a boundary BZ2 that is a left end portion of the region WZ2 of the white object, gray changes to white, thereby changing the received light amount such that the received light amount rises as depicted in an upper center portion in FIG. 3. This results in detection of a positive event.

On the other hand, at a boundary BZ1 that is a right end portion of the region WZ2 of the white object, white changes to gray, thereby changing the received light amount such that the received light amount falls as depicted in an upper right portion in FIG. 3. This results in detection of a negative event.

The negative event detected at the boundary BZ1 and the positive event detected at the boundary BZ2 are detected at the same time. However, due to the occurrence of a delay (latency), information about a time delayed from the time at which the event actually occurred is recorded in the event data.

That is, even if the positive event and the negative event depicted in the upper center portion and the upper right portion in FIG. 3 actually occur at time t11, time t12 delayed by latency TL1 which is a predetermined delay time, for example, is recorded as the information about the time of the event data.

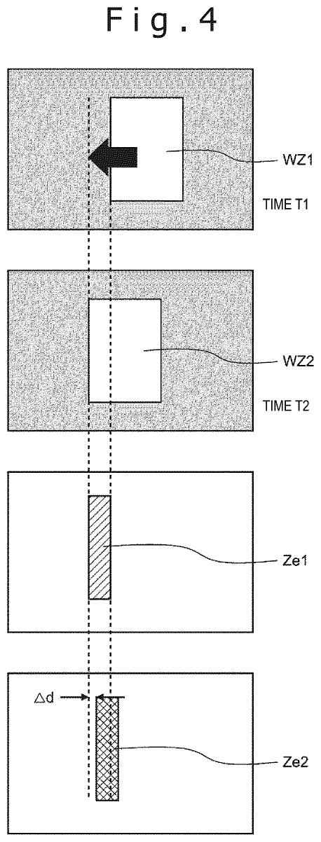

As a result, in a case of movement from the region WZ1 where a white object is present at time T1 as depicted in the topmost portion in FIG. 4 to the region WZ2 at time T2 as depicted in the second portion from the top in FIG. 4, a positive event is detected in a region Ze1 such as depicted in the third portion from the top in FIG. 4 when latency does not exist and the time at which the event actually occurs is appropriately reflected.

However, due to the effects of latency, time information delayed from the time at which the actual event occurred is recorded, and thus the region in which the positive event is detected becomes a past region Ze2 shifted in a right direction in the drawing by a distance Δd according to the latency TL1 with respect to the actual region Ze1, as depicted in bottommost portion in FIG. 4.

Therefore, conceivably, a correction is made by subtracting an amount equivalent to the latency T1 that is a predetermined delay time from the time information about the event data.

However, latency is known to be shorter as the received light amount increases, and, conversely, longer as the received light amount decreases. Therefore, subtracting, as a specific delay time, the delay time caused by latency from the time information does not necessarily result in an appropriate correction.

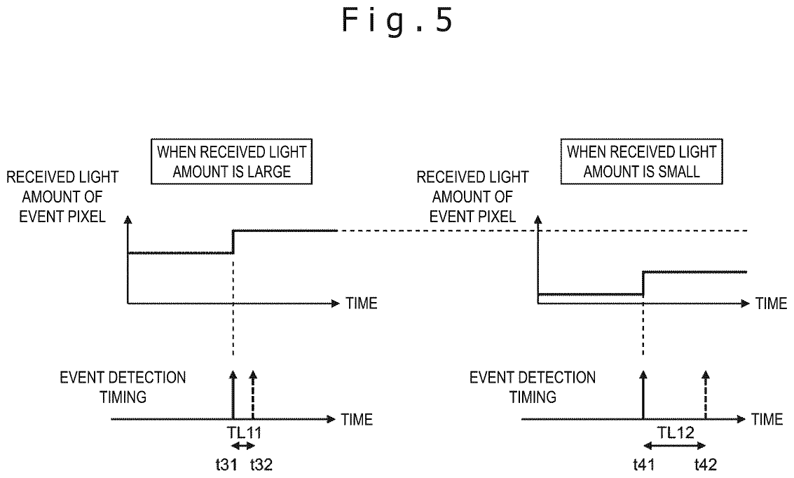

That is, in a case in which a positive event occurs in a state in which the received light amount is large as compared with the case in FIG. 3, for example, when the positive event actually occurs at time t31 as depicted in the left portion in FIG. 5, the time information about the event data is time t32 obtained by delaying the time t31 by latency TL11, which is shorter than the latency TL1.

In contrast, in a case in which a positive event occurs in a state in which the received light amount is small as compared with the case in FIG. 3, for example, when the positive event actually occurs at time t41 as depicted in the right portion in FIG. 5, the time information about the event data is time t42 obtained by delaying the time t41 by latency TL12, which is longer than the latency TL1.

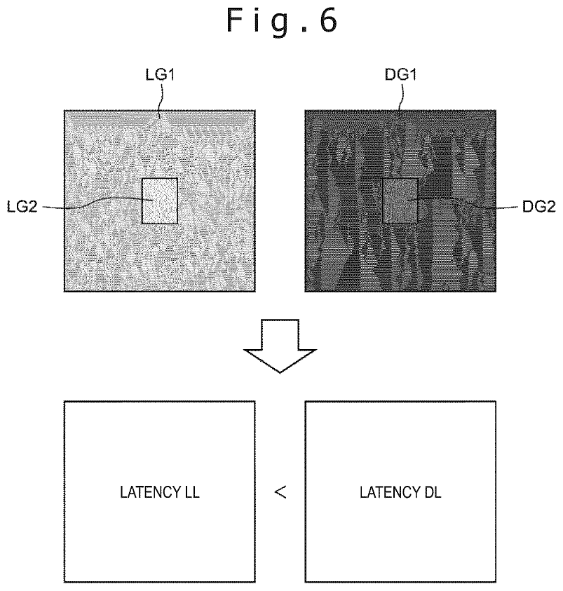

Accordingly, for example, latency LL generated in a case in which a foreground region LG2 of a light gray color moves on a background region LG1 indicated in a gray color darker than that of the foreground region LG2 and having a relatively high received light amount as depicted in the upper left portion in FIG. 6 is smaller than latency DL generated in a case in which a foreground region DG2 of a dark gray color moves on a background region DG1 indicted in a gray color darker than that of the foreground region DG2 and having a relatively low received light amount as depicted in the upper right portion in FIG. 6.

That is, a length of the latency changes in accordance with the received light amount, making it impossible to appropriately reduce the effects caused by the latency by subtracting a specific time from the time information.

Here, in the present disclosure, the received light amount detected by the event signal detection sensor is detected, and the time information in the event data is corrected by the latency corresponding to the detected received light amount.

Thus, latency can be corrected in accordance with a length corresponding to the received light amount, and the effects caused by the latency are appropriately reduced in accordance with the received light amount.

This makes it possible to, for example, achieve correction such that the region where the positive event is detected approaches the region Za1 from the region Za2 in FIG. 4, and thus appropriately reduce the effects caused by the latency in accordance with the received light amount.

### 2. First Embodiment

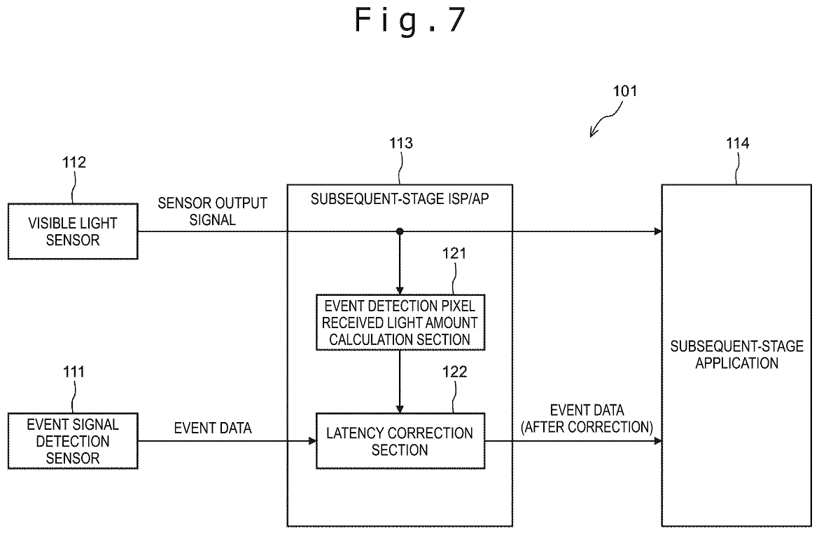

Next, a configuration example of the signal processing device of the present disclosure will be described with reference to FIG. 7. A signal processing device 101 in FIG. 7 includes an event signal detection sensor 111, a visible light sensor 112, a subsequent-stage image sensor processor (ISP)/application processor (AP) 113, and a subsequent-stage application 114.

The event signal detection sensor 111 has the same configuration as that of the event signal detection sensor 11 in FIG. 1, detects a positive event or a negative event in accordance with a change in the received light amount, and outputs event data corresponding to the detection result to the subsequent-stage ISP/AP 113.

The visible light sensor 112 is a sensor that detects the received light amount of the visible light received by the event signal detection sensor 111, and outputs a sensor output signal corresponding to the detected received light amount to the subsequent-stage ISP/AP 113.

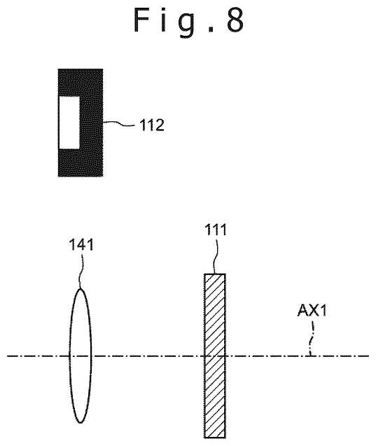

More specifically, as depicted in FIG. 8, the visible light sensor 112 is not disposed on an optical axis AX1 of a lens 141 provided in a preceding stage of the event signal detection sensor 111 and configured to collect light incident on the event signal detection sensor 111, but is disposed relatively close to the optical axis AX1.

With such an arrangement, the visible light sensor 112 detects a received light amount that can be regarded as being approximate to the received light amount of the event signal detection sensor 111, and outputs the received light amount to the subsequent-stage ISP/AP 113 as a sensor output signal. The visible light sensor 112 detects the sensor output signal indicating the received light amount at one point in the vicinity the optical axis AX1, and thus the received light amount calculated on the basis of the sensor output signal is calculated under the assumption that all pixels included in the event signal detection sensor 111 receive the same amount of received light.

The subsequent-stage ISP/AP 113 includes a processor consisting of hardware, calculates the received light amount of the event signal detection sensor 111 on the basis of the sensor output signal from the visible light sensor 112, and specifies the latency correction amount of the event data in accordance with the calculated received light amount.

Then, the subsequent-stage ISP/AP 113 corrects the latency of the event data from the event signal detection sensor 111 by the specified latency correction amount, and outputs the corrected event data to the subsequent-stage application 114.

At this time, the subsequent-stage ISP/AP 113 outputs the sensor output signal supplied from the visible light sensor 112 to the subsequent-stage application 114.

More specifically, the subsequent-stage ISP/AP 113 includes an event detection pixel received light amount calculation section 121 and a latency correction section 122.

The event detection pixel received light amount calculation section 121 calculates a received light amount per unit time of an event detection pixel (corresponding to the pixel 31 in FIG. 2) constituting the event signal detection sensor 111 on the basis of the sensor output signal, and outputs the received light amount to the latency correction section 122.

The event detection pixel received light amount calculation section 121 calculates, as the received light amount per unit time of the event detection pixel constituting the event signal detection sensor 111, a photon quantity per unit time incident on one event detection pixel constituting the event signal detection sensor 111, an irradiance [W/m2], or a luminance [Lux], for example, on the basis of the sensor output signal.

Note that, although FIG. 7 and FIG. 8 depict an example in which one visible light sensor 112 is provided for one event signal detection sensor, a configuration may be adopted in which a plurality of visible light sensors are provided for one event signal detection sensor. In a case in which a plurality of visible light sensors 112 are provided for one event signal detection sensor, the received light amount for each pixel may be calculated by using interpolation based on a positional relationship between each of the plurality of visible light sensors 112 and the event signal detection sensor 111.

The latency correction section 122 specifies the latency on the basis of the received light amount per unit time of the pixel constituting the event signal detection sensor 111 supplied from the event detection pixel received light amount calculation section 121, corrects a time stamp that is time information included in the event data by using the specified latency as a correction amount (hereinafter, also referred to as latency correction amount), and outputs the event data with the corrected time stamp as corrected event data.

Note that, in the present embodiment, the event signal detection sensor 111 adds the information about a time stamp, which is time information, to the event data when generating the event data, and then outputs the result, but the latency correction section 122 may add a time stamp to the event data output from the event signal detection sensor 111, and may further add a correction corresponding to the latency.

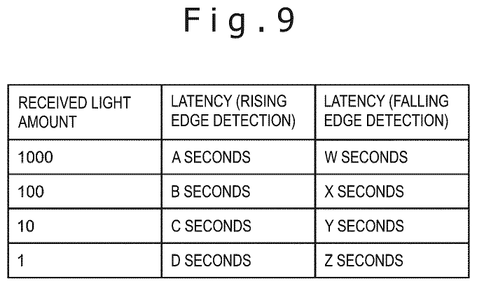

More specifically, the latency correction section 122 stores a table registering the latency for each event corresponding to the received light amount as shown in FIG. 9, for example, reads out the latency in the vicinity of the received light amount supplied from the event detection pixel received light amount calculation section 121, and calculates the corresponding latency by interpolation.

In the table in FIG. 9, the received light amount, the latency in rising edge detection which is a positive event, and the latency in falling edge detection which is a negative event are registered in this order from the left.

In FIG. 9, in a case in which the received light amount is 1000, it is registered that the latency is A seconds when the event is positive and that the latency is W seconds when the event is negative.

Further, in a case in which the received light amount is 100, it is registered that the latency is B seconds when the event is positive and that the latency is X seconds when the event is negative.

Furthermore, in a case in which the received light amount is 10, it is registered that the latency is C seconds when the event is positive, and the latency is Y seconds when the event is negative.

Further, in a case in which the received light amount is 1, it is registered that the latency is D seconds when the event is positive, and the latency is Z seconds when the event is negative.

A table such as shown in FIG. 9 registers the latencies determined for positive events and negative events in correspondence with received light amounts through experiments, simulations, and the like conducted in advance.

For example, in a case in which the received light amount is 500 and the event is positive, the latency correction section 122 reads out, from the table, A seconds of the positive event at the received light amount of 1000 and B seconds of the positive event at the received light amount of 100, which are in the vicinity of the received light amount of 500, calculates the latency when the received light amount is 500 by interpolation by using, for example, a logarithmic average or the like, sets the calculation result as the latency correction amount, and corrects the time stamp that is the time information by the latency correction amount.

The subsequent-stage application 114 consists of software such as an application program, and executes signal processing based on the event data after the latency is corrected and the sensor output signal.

In the signal processing device 101 in FIG. 7, as described above, the sensor output signal according to the received light amount is output from the visible light sensor 112, the received light amount of the event detection pixel is calculated on the basis of the sensor output signal, and, on the basis of the calculated received light amount of the event detection pixel, the time stamp is corrected on the basis of the latency correction amount corresponding to the received light amount, which is measured in advance through experiments or the like.

As a result, the latency correction amount corresponding to the received light amount of the event signal detection sensor 111 is specified, and the time stamp that is the time information is corrected by the specified latency correction amount, making it possible to appropriately reduce the effects caused by the latency.

### Signal Processing by Signal Processing Device in FIG. 7

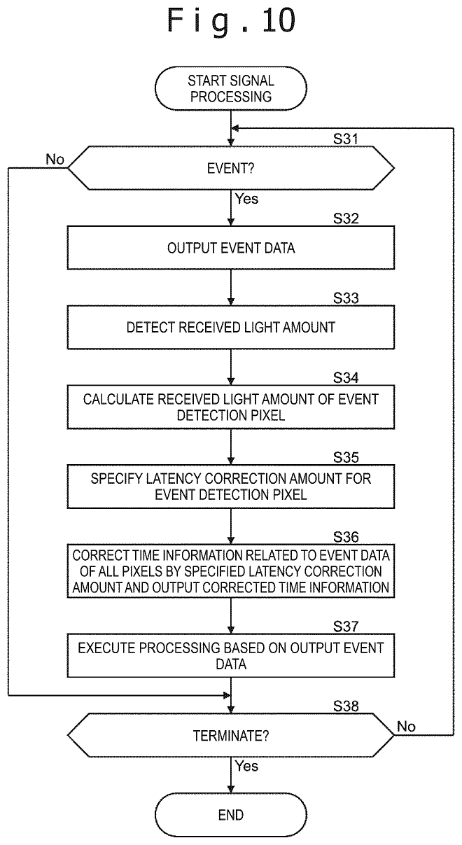

Next, the signal processing by the signal processing device 101 in FIG. 7 will be described with reference to a flowchart in FIG. 10.

In step S31, the event signal detection sensor 111 determines whether an event has been detected. In a case in which the determination is made in step S31 that an event has been detected, the processing proceeds to step S32.

In step S32, the event signal detection sensor 111 outputs the event data to the latency correction section 122 of the subsequent-stage ISP/AP 113.

In step S33, the visible light sensor 112 outputs a sensor output signal corresponding to the received light amount of visible light to the event detection pixel received light amount calculation section 121 of the subsequent-stage ISP/AP 113. At this time, the sensor output signal is also output to the subsequent-stage application 114.

In step S34, the event detection pixel received light amount calculation section 121 calculates the received light amount per unit time of the event detection pixel constituting the event signal detection sensor 111 on the basis of the sensor output signal corresponding to the received light amount of visible light, and outputs the received light amount, which is the calculation result, to the latency correction section 122.

In step S35, the latency correction section 122 reads out the latency registered in association with the received light amount from the stored table, and specifies the latency correction amount by performing interpolation or the like, as necessary.

In step S36, the latency correction section 122 corrects the time stamp, which is the time information, registered in the event data, by the latency correction amount, and outputs the result to the subsequent-stage application 114.

In step S37, the subsequent-stage application 114 executes signal processing based on the corrected event data and the sensor output signal, and outputs the execution result.

Further, in a case in which an event has not been detected in step S31, the processing of steps S32 to S37 is skipped.

In step S38, the determination is made as to whether termination of the processing has been instructed, and, in a case in which termination has not been instructed, the processing returns to step S31, and the subsequent processing is repeated.

Then, in step S38, in a case in which termination of the processing has been instructed, the processing ends.

Through the processing described above, the latency correction amount is specified in accordance with the received light amount, and the time stamp that is the time information about the event data is corrected by the specified latency correction amount.

As a result, the time information is corrected by setting an appropriate latency correction amount for the latency that changes in accordance with the received light amount, making it possible to appropriately reduce the effects of the latency.

### 3. Second Embodiment

In the above, an example has been described in which the visible light sensor 112 is provided in the vicinity of the event signal detection sensor 111, the received light amount of the event signal detection sensor 111 is calculated on the basis of the sensor output signal of the visible light sensor 112, the latency correction amount is determined in accordance with the calculated received light amount, and the time stamp that is time information is corrected by the latency correction amount according to the received light amount.

However, the received light amount varies in units of pixels constituting the event signal detection sensor 111, and thus the latency of the event data varies in units of pixels constituting the event signal detection sensor 111.

Therefore, a complementary metal oxide semiconductor (CMOS) image sensor may be provided instead of the visible light sensor 112, the received light amount of each pixel in the event signal detection sensor 111 may be specified from a gradation signal of each pixel, and the latency may be corrected in units of pixels.

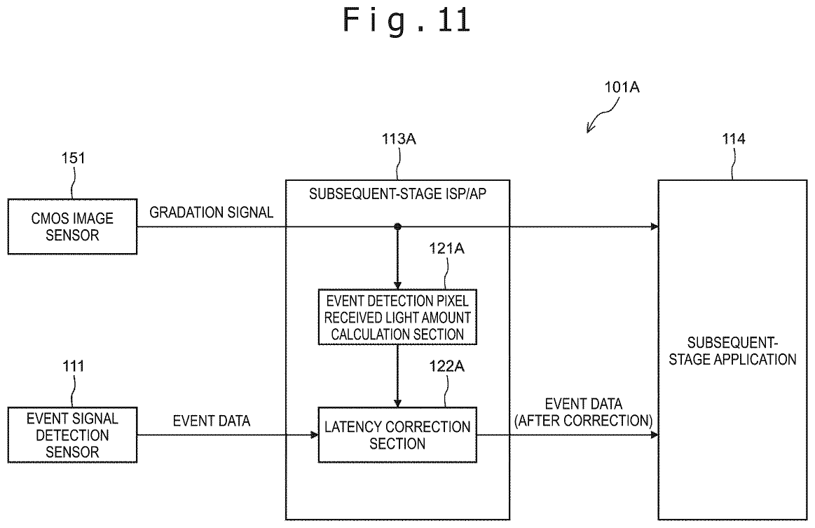

FIG. 11 depicts a configuration example of a signal processing device in which a CMOS image sensor is provided instead of the visible light sensor 112, the received light amount of each pixel in the event signal detection sensor 111 is specified from the gradation signal of each pixel, and the latency is corrected in units of pixels.

In a signal processing device 101A in FIG. 11, components having the same functions as those of the signal processing device 101 in FIG. 7 are denoted using the same reference signs, and the description thereof will be omitted as appropriate. Further, in the signal processing device 101A in FIG. 11, components having functions similar to those of the signal processing device 101 in FIG. 7 are denoted using the same reference signs followed by “A”.

The signal processing device 101A in FIG. 11 differs from the signal processing device 101 in FIG. 7 in that a CMOS image sensor 151 is provided instead of the visible light sensor 112, and a subsequent-stage ISP/AP 113A is provided instead of the subsequent-stage ISP/AP 113.

The CMOS image sensor 151 includes a plurality of pixels disposed in an array in a direction perpendicular to an incident direction of incident light, and outputs a gradation signal corresponding to an amount of incident light to the subsequent-stage ISP/AP 113 on a pixel-by-pixel basis.

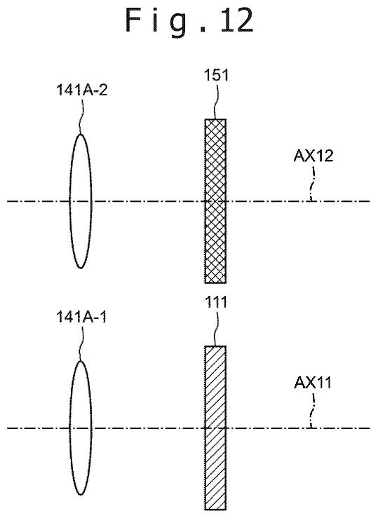

More specifically, as depicted in FIG. 12, the CMOS image sensor 151 is provided with a lens 141A-2 that condenses incident light in a preceding stage thereof. Further, at a front end of the event signal detection sensor 111 as well, a lens 141A-1 that condenses incident light incident on the event signal detection sensor 111 is provided.

Optical axes AX11 and AX12 of the lenses 141A-1 and 141A-2 are not identical, but are disposed relatively close and parallel to each other. Therefore, although parallax occurs between each pixel of the CMOS image sensor 151 and each pixel of the event signal detection sensor 111 with respect to an object within a range relatively close to both, the gradation signal in each pixel of the CMOS image sensor 151 can be considered to generally correspond to the received light amount of each pixel of the event signal detection sensor 111.

Therefore, the CMOS image sensor 151 outputs the gradation signal in units of pixels to the subsequent-stage ISP/AP 113A as information for detecting the received light amount that can be regarded as being approximate to the received light amount of each pixel of the event signal detection sensor 111. In other words, the gradation signal indicating the received light amount output from the CMOS image sensor 151 is output as information indicating the received light amount of the pixel at the corresponding position configured in the event signal detection sensor 111.

The subsequent-stage ISP/AP 113A has the same basic functions as those of the subsequent-stage ISP/AP 113 in FIG. 7, but calculates the received light amount in units of pixels in the event signal detection sensor 111 on the basis of the event data from the event signal detection sensor 111 and the gradation signal from the CMOS image sensor 151, and specifies the latency correction amount in units of pixels according to the calculated received light amount.

The subsequent-stage ISP/AP 113A corrects the latency of the event data with the latency correction amounts specified per pixel, and outputs the event data corrected in units of pixels to the subsequent-stage application 114.

At this time, the subsequent-stage ISP/AP 113A outputs the sensor output signal supplied from the visible light sensor 112 to the subsequent-stage application 114.

More specifically, the subsequent-stage ISP/AP 113A includes an event detection pixel received light amount calculation section 121A and a latency correction section 122A.

The event detection pixel received light amount calculation section 121A has the same functions as those of the event detection pixel received light amount calculation section 121, but calculates the received light amount per unit time for each event detection pixel constituting the event signal detection sensor 111 on the basis of the gradation signal in units of pixels, and outputs the calculated received light amount to the latency correction section 122A.

The event detection pixel received light amount calculation section 121A calculates the received light amount per unit time for each pixel of the event detection pixels constituting the event signal detection sensor 111 on the basis of the gradation signal of each pixel of the CMOS image sensor 151.

For example, in a case in which the received light amount per unit time for each pixel is determined as irradiance [W/m²], the calculation is performed by the procedure below.

First, a charge amount per unit time of each pixel is determined by equation (1) below.

$$Qu = ( ( Qu\_after - gain / gain ) / Te \qquad ( 1 )$$

Here, Qu is a charge amount per unit time in units of pixels, and Q_after-gain is a charge amount after the gain is applied in units of pixels of the CMOS image sensor 151 and is expressed by equation (2) below. Further, gain is a value of the applied gain and is expressed by equation (3) below.

$$Qu\_after - gain = ( Vs - OPB ) / slope \qquad ( 2 )$$

$$slope = ( ( {2}^{10} - 1 ) - OPB ) / Qs$$

$$gain = 10 \hat{} ( Vg [ dB ] / 20 ) \qquad ( 3 )$$

$$Vg [ dB ] = 20 log ( gain )$$

Here, Vs is the value of the gradation signal, OPB is the gradation signal (generally 64) of a light-shielding pixel called optical black, Qs is a saturation charge amount of the pixel, and Vg is the gain value [dB]. In addition, “\hat{ }” represents exponentiation.

Then, in a case in which the spectrum of the incident light is known, the event detection pixel received light amount calculation section 121A calculates the received light amount per unit time for each pixel as the irradiance [W/m²] by calculation with equation (4) below on the basis of the determined charge amount per unit time for each pixel.

$$IRR = Qu 1 / Qg \qquad ( 4 )$$

Here, IRR is the irradiance [W/m²] of the received light amount per unit time for each pixel, Qu1 is a charge amount generated in a pixel per second in units of pixels, and Qg is a charge amount per second that can be generated by photoelectric conversion of light having an irradiance of 1 [W/m^{2]}.

Note that the charge amount Og per second that can be generated by the photoelectric conversion of light having an irradiance of 1 [W/m²] needs to be determined in advance through experiments or theoretical calculations in accordance with the spectrum.

Then, the event detection pixel received light amount calculation section 121A, upon determination of the received light amount per unit time for each pixel of the CMOS image sensor 151, converts the coordinates to those of the corresponding pixel position on the event signal detection sensor 111 for each pixel, and sets the received light amount as the received light amount of the corresponding pixel.

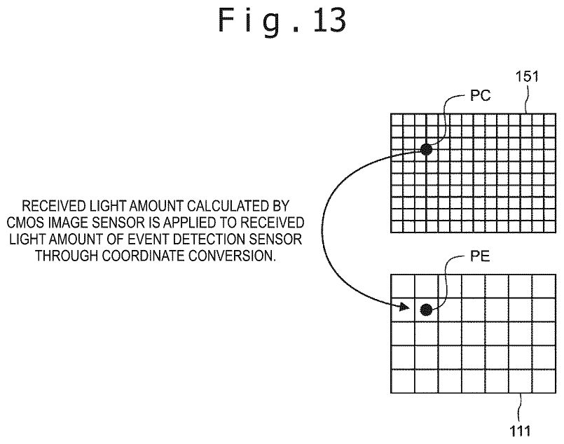

More specifically, the event detection pixel received light amount calculation section 121A, upon determination of the received light amount per unit time of a pixel PC of the CMOS image sensor 151, converts the coordinates to those of a corresponding pixel PE on the event signal detection sensor 111, and applies the received light amount per unit time as the received light amount of the pixel PE obtained by the coordinate conversion, as depicted in FIG. 13.

Further, in the above, the assumption is made that the spectrum is known. However, in a case in which the CMOS image sensor 151 is constituted of RGB pixels, the event detection pixel received light amount calculation section 121A may predict, in units of pixels of the event signal detection sensor 111, the spectrum from a ratio of a charge amount of each RGB pixel, and calculate the received light amount per unit time for each pixel by the calculation of equations (1) to (4) described above on the basis of the prediction result of the spectrum for each pixel.

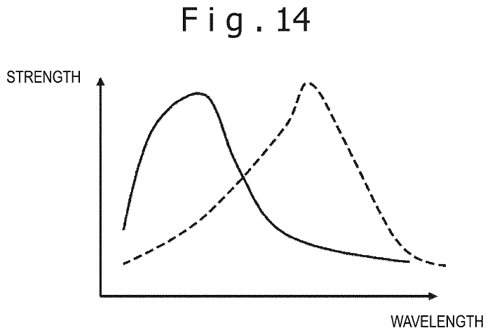

For example, in a case in which the charge amount of the B pixel is greater than the charge amounts of the G pixel and the R pixel, there is a high possibility that the spectrum has a peak in a short wavelength region and thus, among waveforms shown in FIG. 14, a spectrum distribution such as indicated by a solid line is predicted, for example.

Further, for example, in a case in which the charge amount of the R pixel is greater than the charge amounts of the G pixel and the B pixel, there is a high possibility that the spectrum has a peak in a long wavelength region and thus, among waveforms shown in FIG. 14, a spectrum distribution as indicated by a dashed line is predicted, for example.

The event detection pixel received light amount calculation section 121A may estimate a spectrum from the ratio of the charge amounts of the RGB pixels by a method such as described with reference to FIG. 14.

Note that, in FIG. 14, the vertical axis represents intensity, the horizontal axis represents wavelength, and waveform examples of spectral distributions represented by the dashed line and the solid line are depicted.

The latency correction section 122A has the same basic functions as those of the latency correction section 122, but specifies a latency correction amount for each pixel on the basis of the received light amount per unit time of each pixel constituting the event signal detection sensor 111 supplied from the event detection pixel received light amount calculation section 121A, corrects the time stamp that is time information included in the event data for each pixel in accordance with the specified latency correction amount for each pixel, and outputs the event data with the time stamp corrected for each pixel as the corrected event data.

That is, the latency correction section 122 corrects the time information about the event data with the latency correction amount common to all pixels, whereas the latency correction section 122A corrects the time information about the event data for each pixel with the latency correction amount for each pixel.

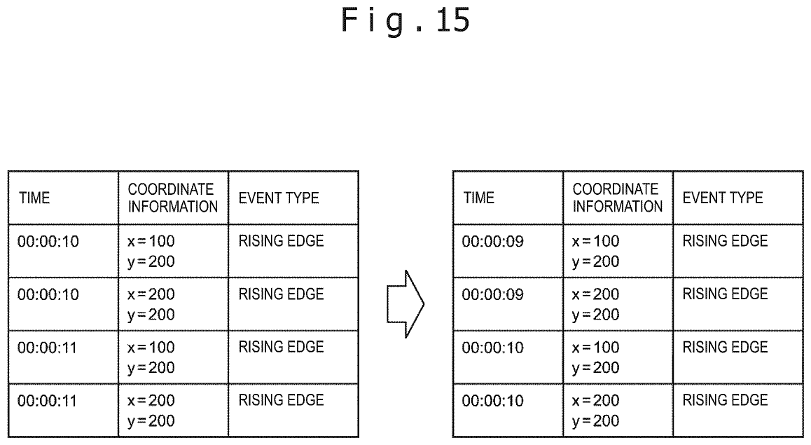

For example, as shown in the left portion in FIG. 15, in a case in which the event data indicates a time stamp that is time information, coordinate information representing a pixel position, and information about an event type that indicates a positive event (rising edge) or a negative event (falling edge) in this order from the left in units of pixels, the latency correction section 122A corrects the time information as shown in the right portion in FIG. 15 when the latency is one second, for example.

Note that, in the event data in the left portion in FIG. 15, the topmost portion indicates that, at the time information 00:00:10, a rising edge that is a positive event is detected in a pixel at a coordinate position (x, y)=(100, 200). The second portion from the top indicates that, at the time information 00:00:10, a rising edge that is a positive event is detected in a pixel at a coordinate position (x, y)=(200, 200). The third portion from the top indicates that, at the time information 00:00:11, a rising edge that is a positive event is detected in a pixel at a coordinate position (x, y)=(100, 200). The fourth portion from the top indicates that, at the time information 00:00:11, a rising edge that is a positive event is detected in a pixel at a coordinate position (x, y)=(200, 200).

Further, in the event data in the right portion in FIG. 15, the topmost portion indicates that, at the time information 00:00:09, a rising edge that is a positive event is detected in a pixel at a coordinate position (x, y)=(100, 200). The second portion from the top indicates that, at the time information 00:00:09, a rising edge that is a positive event is detected in a pixel at a coordinate position (x, y)=(200, 200). The third portion from the top indicates that, at the time information 00:00:10, a rising edge that is a positive event is detected in a pixel at a coordinate position (x, y)=(100, 200). The fourth portion from the top indicates that, at the time information 00:00:10, a rising edge that is a positive event is detected in a pixel at a coordinate position (x, y)=(200, 200).

That is, the time information in the original event data shown in the left portion in FIG. 15 is corrected in the right portion in FIG. 15 by subtracting one second, which is the latency correction amount.

Further, in the above, an example has been described in which, among the event data, the time information is corrected by the latency correction amount. However, the corrected time information may be added.

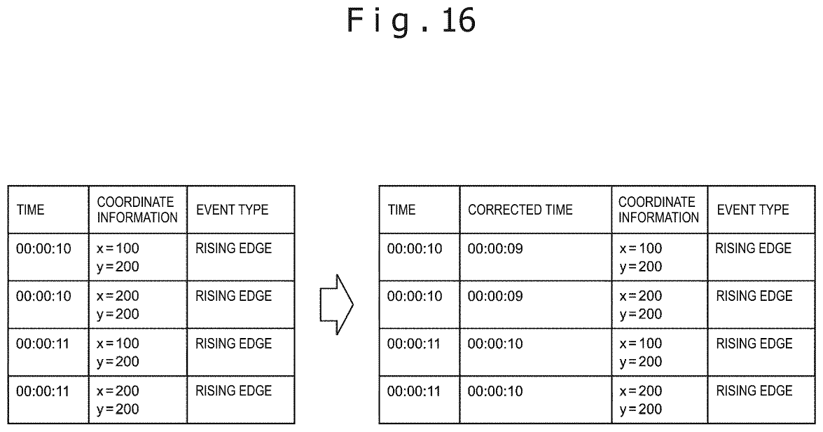

For example, as shown in the right portion in FIG. 16, the corrected time information may be added to event data such as shown in the left portion in FIG. 16.

The left portion in FIG. 16 is the same as the left portion in FIG. 15, and the right portion in FIG. 16 has a corrected time information column additionally recorded between the time information column and the coordinate information column of the right portion in FIG. 15.

Note that the latency correction amount differs in units of pixels. Thus, a column in which a delay time corresponding to latency, that is, the latency correction amount, is recorded may be used instead of the column of the corrected time information in the right portion in FIG. 16, and time information obtained by correcting the original time information by the latency correction amount may be actually used.

### Signal Processing by Signal Processing Device in FIG. 11

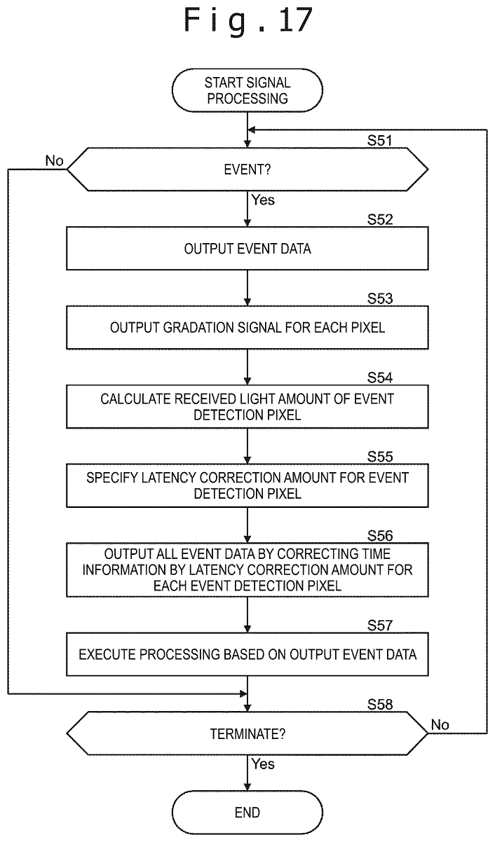

Next, the signal processing by the signal processing device 101A in FIG. 11 will be described with reference to a flowchart in FIG. 17.

In step S51, the event signal detection sensor 111 determines whether an event has been detected. In a case in which the determination is made in step S51 that an event has been detected, the processing proceeds to step S52.

In step S52, the event signal detection sensor 111 outputs the event data to the latency correction section 122A of the subsequent-stage ISP/AP 113A.

In step S53, the CMOS image sensor 151 outputs the gradation signal of each pixel to the event detection pixel received light amount calculation section 121A of the subsequent-stage ISP/AP 113A. At this time, the gradation signal is also output to the subsequent-stage application 114.

In step S54, the event detection pixel received light amount calculation section 121A calculates the received light amount per unit time in units of pixels of the event detection pixel constituting the event signal detection sensor 111 on the basis of the gradation signal in units of pixels, and outputs the received light amount for each pixel that is the calculation result to the latency correction section 122A.

In step S55, the latency correction section 122A reads out, for each pixel, the latency registered in association with the received light amount from the stored table, and specifies the latency correction amount for each pixel by performing interpolation or the like, as necessary.

In step S56, the latency correction section 122A corrects, for each pixel, the time stamp, which is the time information registered in the event data, by the latency correction amount, and outputs the result to the subsequent-stage application 114.

In step S57, the subsequent-stage application 114 executes signal processing based on the corrected event data and the gradation signal, and outputs the execution result.

Further, in a case in which an event has not been detected in step S51, the processing of steps S52 to S57 is skipped.

In step S58, the determination is made as to whether termination of the processing has been instructed, and, in a case in which termination has not been instructed, the processing returns to step S51, and the subsequent processing is repeated.

Then, in step S58, in a case in which termination of the processing has been instructed, the processing ends.

Through the processing described above, the latency correction amount for each pixel is specified in accordance with the received light amount for each pixel, and the time stamp that is the time information about the event data is corrected for each pixel by the specified latency correction amount for each pixel.

As a result, the time information is corrected in units of pixels by setting an appropriate latency correction amount for the latency that changes in accordance with the received light amount in units of pixels, making it possible to appropriately reduce the effects of the latency.

### 4. Third Embodiment

In the above, an example has been described in which the time stamp that is the time information in the event data is corrected by the latency correction amount corresponding to the received light amount. However, only the information about the received light amount may be added to the event data, and the latency corresponding to the received light amount may be corrected in the subsequent-stage application 114 that has acquired the event data.

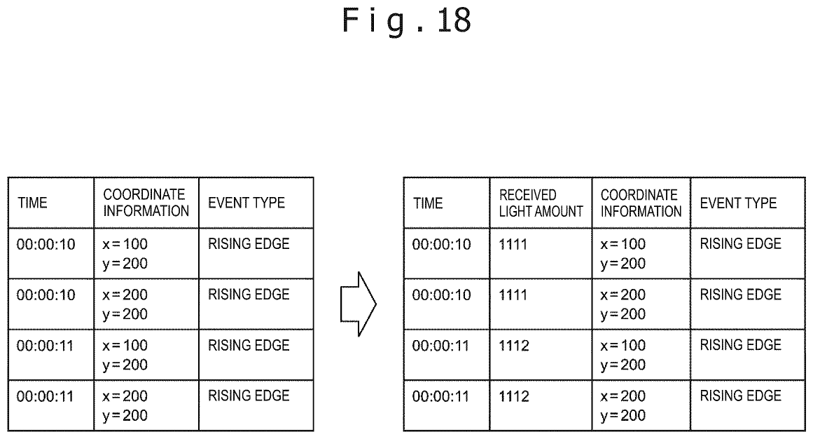

That is, for example, as shown in the right portion in FIG. 18, information about the received light amount is added to original event data such as shown in the left portion in FIG. 18, and the result is output to the subsequent-stage application 114. In the subsequent-stage application 114, the latency is corrected on the basis of the event data to which the received light amount is added, and the processing is subsequently executed.

Note that the left portion in FIG. 18 is the original event data, similar to the left portions in FIG. 15 and FIG. 16, while the right portion in FIG. 18 has a received light amount column for the corresponding pixels provided between the time stamp column indicating the time information and the coordinate information column indicating pixel positions in the left portion in FIG. 18.

In the received light amount column in the right portion in FIGS. 18, 1111, 1111, 1112, and 1112 are registered as the received light amounts in this order from the top.

That is, the topmost portion in the right portion in FIG. 18 indicates that, at the time information 00:00:10, a rising edge that is a positive event is detected in a pixel at a coordinate position (x, y)=(100, 200), and the received light amount is 1111. The second portion from the top indicates that, at the time information 00:00:10, a rising edge that is a positive event is detected in a pixel at a coordinate position (x, y)=(200, 200), and the received light amount is 1111. The third portion from the top indicates that, at the time information 00:00:11, a rising edge that is a positive event is detected in a pixel at a coordinate position (x, y)=(100, 200), and the received light amount is 1112. The fourth portion from the top indicates that, at the time information 00:00:11, a rising edge that is a positive event is detected in a pixel at a coordinate position (x, y)=(200, 200), and the received light amount is 1112.

The subsequent-stage application 114 determines a latency correction amount corresponding to the received light amount on the basis of the event data corrected by the application of the information about the received light amount, corrects the time stamp that is the time information, and executes the processing.

### Configuration Example of Signal Processing Device Configured to Register Received Light Amount in Event Data

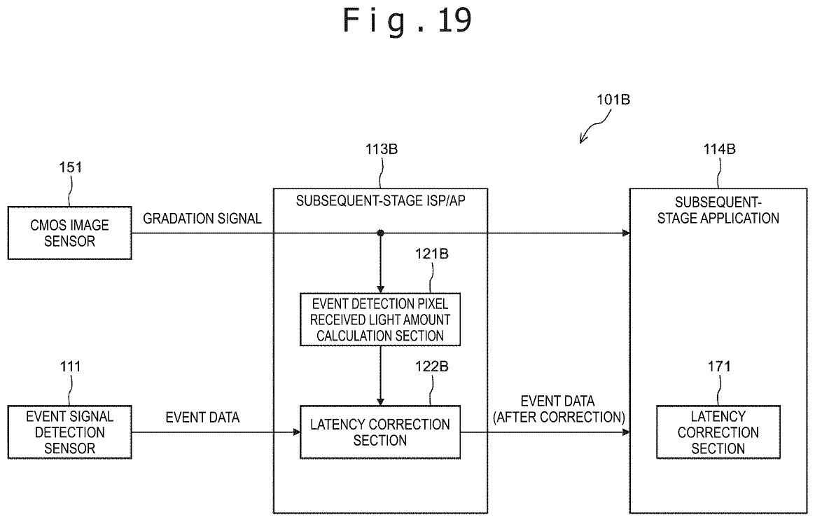

FIG. 19 depicts a configuration example of a signal processing device configured to register the received light amount in the event data.

In a signal processing device 101B in FIG. 19, components having the same functions as those of the signal processing device 101 in FIG. 7 and the signal processing device 101A in FIG. 11 are denoted using the same reference signs, and the description thereof will be omitted as appropriate. Further, in the signal processing device 101B in FIG. 19, components having functions similar to those of the signal processing device 101 in FIG. 7 and the signal processing device 101A in FIG. 11 are denoted using the same reference signs followed by “B”.

The signal processing device 101B in FIG. 19 differs from the signal processing device 101 in FIG. 7 and the signal processing device 101A in FIG. 11 in that a subsequent-stage ISP/AP 113B and a subsequent-stage application 114B are provided instead of the subsequent-stage ISP/APs 113 and 113A and the subsequent-stage application 114.

More specifically, the subsequent-stage ISP/AP 113B includes an event detection pixel received light amount calculation section 121B and a latency correction section 122B.

The event detection pixel received light amount calculation section 121B has the same functions as those of the event detection pixel received light amount calculation section 121A, calculates the received light amount per unit time for each event detection pixel constituting the event signal detection sensor 111, and outputs the received light amounts to the latency correction section 122B.

The latency correction section 122B, as described with reference to FIG. 18, adds the received light amount for each event detection pixel to the event data supplied from the event signal detection sensor 111, and outputs the result to the subsequent-stage application 114B as the corrected event data.

That is, unlike the latency correction sections 122 and 122A, the latency correction section 122B does not correct the time stamp, which is the time information included in the event data, and outputs the event data only by adding the information about the received light amount.

Note that the latency correction section 122B does not correct the time stamp that is the time information, but provides information about the received light amount that is required when the time stamp that is the time information about the event data is corrected, and thus achieves the function of correcting the event data.

The subsequent-stage application 114B has the same basic functions as those of the subsequent-stage application 114, but further corrects the time stamp that is time information by the latency correction amount on the basis of the event data with the information about the received light amount added thereto, and executes the processing.

More specifically, the subsequent-stage application 114B includes a latency correction section 171. The latency correction section 171 includes a table (similar to the table in FIG. 9) consisting of received light amounts and corresponding latencies (latency correction amounts), reads out the corresponding latency correction amount from the table on the basis of the information about the received light amount included in the event data, and corrects the time stamp that is the time information.

### Signal Processing by Signal Processing Device in FIG. 19

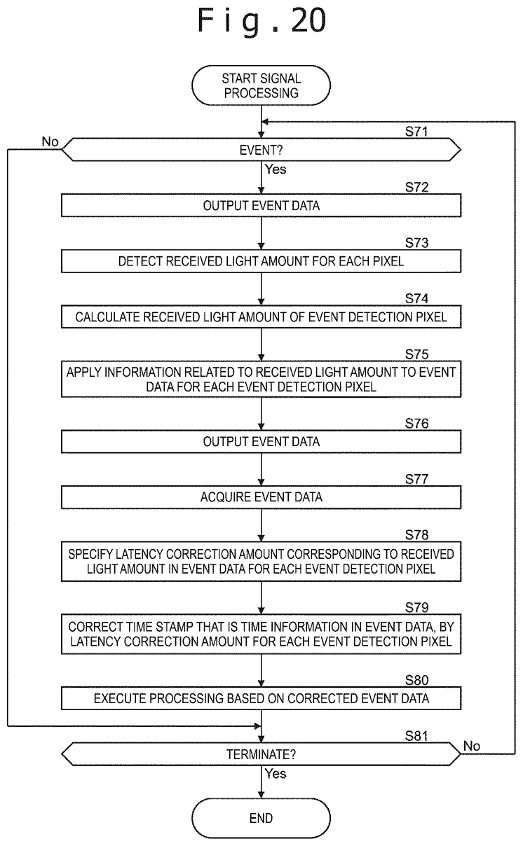

Next, the signal processing by the signal processing device 101B in FIG. 19 will be described with reference to a flowchart in FIG. 20.

In step S71, the event signal detection sensor 111 determines whether an event has been detected. In a case in which the determination is made in step S71 that an event has been detected, the processing proceeds to step S72.

In step S72, the event signal detection sensor 111 outputs the event data to the latency correction section 122B of the subsequent-stage ISP/AP 113B.

In step S73, the CMOS image sensor 151 outputs the gradation signal of each pixel to the event detection pixel received light amount calculation section 121B of the subsequent-stage ISP/AP 113B. At this time, the gradation signal is also output to the subsequent-stage application 114B.

In step S74, the event detection pixel received light amount calculation section 121B calculates the received light amount per unit time in units of pixels of the event detection pixels constituting the event signal detection sensor 111 on the basis of the gradation signal in units of pixels, and outputs the received light amount for each pixel that is the calculation result to the latency correction section 122B.

In step S75, the latency correction section 122B corrects the event data by adding the information about the received light amount to the event data for each pixel.

In step S76, the latency correction section 122B outputs, to the subsequent-stage application 114B, the event data corrected by the addition of the information about the received light amount, for each pixel.

In step S77, the subsequent-stage application 114B acquires the event data corrected by the addition of the information about the received light amount, for each pixel.

In step S78, the latency correction section 171 of the subsequent-stage application 114B reads out information about the received light amount for each pixel from the event data, and searches for and specifies a corresponding latency correction amount from the table in which latencies for received light amounts are recorded.

In step S79, the latency correction section 171 corrects, in the event data, the time stamp that is time information by the latency correction amount for each pixel.

In step S80, the subsequent-stage application 114B executes the signal processing based on the event data with the corrected time stamp that is time information and the gradation signal, and outputs the execution result.

Further, in a case in which an event has not been detected in step S71, the processing of steps S72 to S80 is skipped.

In step S81, the determination is made as to whether termination of the processing has been instructed, and, in a case in which termination has not been instructed, the processing returns to step S71, and the subsequent processing is repeated.

Then, in step S81, in a case in which termination of the processing has been instructed, the processing ends.

Through the processing described above as well, the latency correction amount for each pixel is specified in accordance with the received light amount for each pixel, and the time stamp that is the time information about the event data is corrected for each pixel by the specified latency correction amount.

As a result, the time information is corrected in units of pixels by setting an appropriate latency correction amount for the latency that changes in accordance with the received light amount in units of pixels, making it possible to appropriately reduce the effects of the latency.

### 5. Fourth Embodiment

In the above, configuration examples of the signal processing devices 101, 101A, and 101B that use the CMOS image sensor 151 and the event signal detection sensor 111 have been described. However, a hybrid event-base vision sensor (EVS) having the functions of both the CMOS image sensor 151 and the event signal detection sensor 111 may be used.

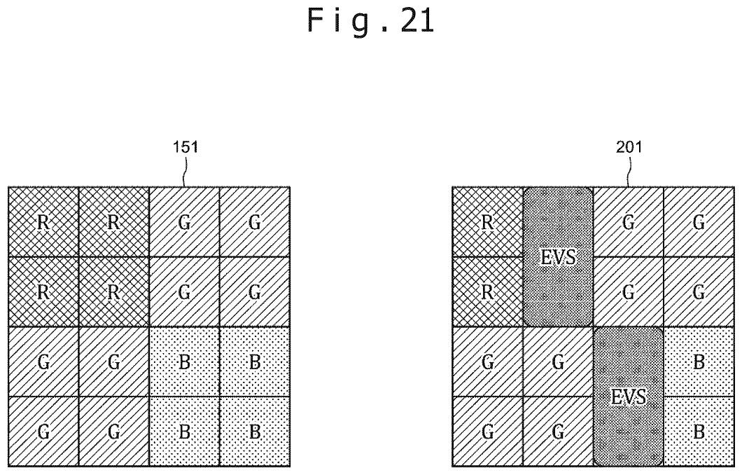

A hybrid EVS sensor has a pixel structure such as depicted in the right portion in FIG. 21, for example. Note that the left portion in FIG. 21 depicts the pixel configuration of the CMOS image sensor 151 and depicts differences in configuration from a hybrid EVS 201 in the right portion in FIG. 21.

That is, the CMOS image sensor 151 has a pixel arrangement in which, as depicted in the left portion in FIG. 21, for example, 2 pixels×2 pixels are set as one pixel unit, and RGB pixel units are disposed in a Bayer array.

In contrast, the hybrid EVS 201 has a configuration in which, in each of the four pixels that constitute the R pixel unit and the four pixels that constitute the B pixel unit in the CMOS image sensor 151, two vertically aligned pixels are replaced with the event detection pixel (corresponding to pixel 31 in FIG. 2) EVS in the event signal detection sensor 111.

With such a configuration, in the hybrid EVS sensor 201, the gradation signal is acquired from the RGB pixels as in the configuration of the CMOS image sensor 151, and the event data is acquired from the event detection pixel EVS.

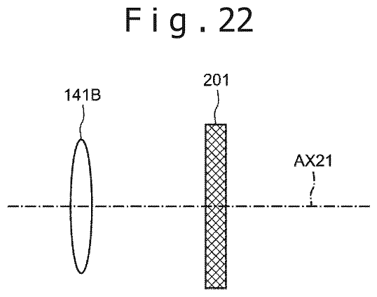

Further, in the hybrid EVS sensor 201, a configuration is adopted in which a lens 141B for condensing light is provided at a front end as depicted in FIG. 22, and thus the gradation signal and the event data acquired in the hybrid EVS 201 can be acquired in a state in which an appropriate positional relationship in which a parallax in arrangement or the like does not occur with respect to an axis AX 21 of the lens 141B is maintained. Note that the pixel array of the hybrid EVS 201 in the right portion in FIG. 21 is an example, and may be a pixel array other than the illustrated pixel array.

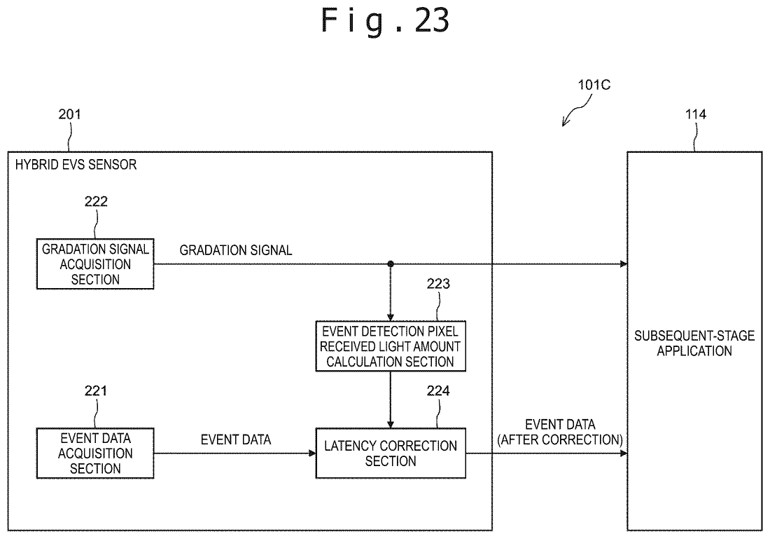

First Configuration Example of Signal Processing Device Using Hybrid EVS FIG. 23 depicts a first configuration example of a signal processing device that uses a hybrid EVS sensor. A signal processing device 101C in FIG. 23 is constituted of the hybrid EVS sensor 201 and the subsequent-stage application 114.

The hybrid EVS sensor 201 includes an event data acquisition section 221, a gradation signal acquisition section 222, an event detection pixel received light amount calculation section 223, and a latency correction section 224.

The event data acquisition section 221 acquires the event data output from the event detection pixels EVS in FIG. 21 and outputs the event data to the latency correction section 224.

The gradation signal acquisition section 222 acquires the gradation signals output from the RGB pixels in FIG. 21, and outputs the gradation signals to the event detection pixel received light amount calculation section 223.

The event data acquisition section 221 functions similarly to the event signal detection sensor 111. Further, the gradation signal acquisition section 222 functions similarly to the CMOS image sensor 151.

The event detection pixel received light amount calculation section 223 and the latency correction section 224 function as the event detection pixel received light amount calculation section 121A or 121B and the latency correction section 122A or 122B, respectively.

That is, the signal processing device 101C in FIG. 23 can substantially function as the signal processing device 101A in FIG. 11 or the signal processing device 101B in FIG. 19.

Note that the respective signal processing is the same, and thus description thereof will be omitted.

### Second Configuration Example of Signal Processing Device Using Hybrid EVS

In the above, a configuration example has been described in which the hybrid EVS sensor 201 includes the event data acquisition section 221, the gradation signal acquisition section 222, the event detection pixel received light amount calculation section 223, and the latency correction section 224. However, a configuration in which only the event data acquisition section 221 and the gradation signal acquisition section 222 are provided may be adopted.

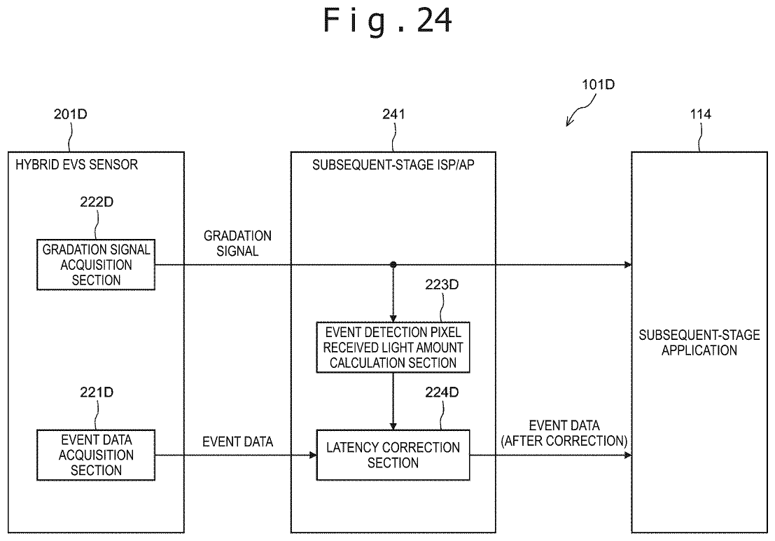

FIG. 24 depicts a configuration example of a signal processing device in a case in which only the event data acquisition section 221 and the gradation signal acquisition section 222 are provided in the hybrid EVS sensor 201.

A signal processing device 101D in FIG. 24 is constituted of a hybrid EVS sensor 201D, a subsequent-stage ISP/AP 241, and the subsequent-stage application 114.

The hybrid EVS sensor 201D has the same basic functions as those of the hybrid EVS sensor 201, but is provided with only an event data acquisition section 221D and a gradation signal acquisition section 222D having the same functions as those of the event data acquisition section 221 and the gradation signal acquisition section 222, respectively.

The subsequent-stage ISP/AP 241 is provided with an event detection pixel received light amount calculation section 223D and a latency correction section 224D having the same functions as those of the event detection pixel received light amount calculation section 223 and the latency correction section 224, respectively.

That is, in the signal processing device 101D in FIG. 24, the functions of the hybrid EVS sensor 201 in FIG. 23 are realized by the hybrid EVS sensor 201D and the subsequent-stage ISP/AP 241.

With such a configuration, the signal processing device 101D in FIG. 24 also substantially realizes functions as the signal processing device 101A in FIG. 11 or the signal processing device 101B in FIG. 19.

### Third Configuration Example of Signal Processing Device Using Hybrid EVS

In the above, an example has been described in which the hybrid EVS sensor 201D is constituted only by the event data acquisition section 221D and the gradation signal acquisition section 222D. However, the functions of the event detection pixel received light amount calculation section 223 may be further provided.

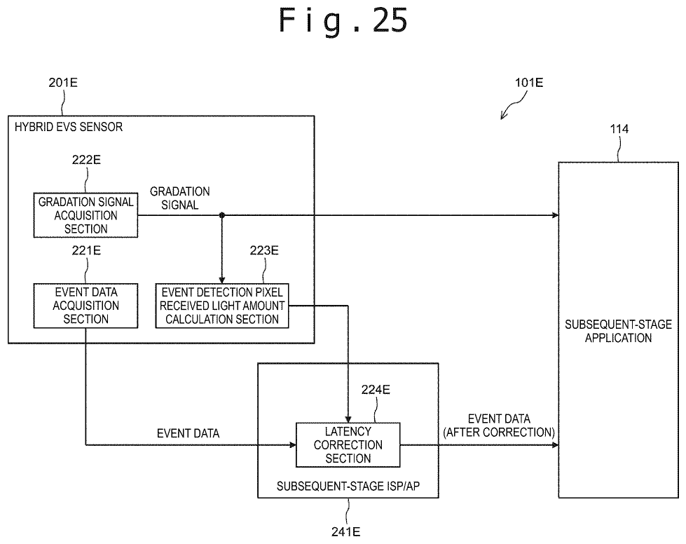

FIG. 25 depicts a configuration example of a signal processing device in a case in which the hybrid EVS sensor 201 is realized by the event data acquisition section 221, the gradation signal acquisition section 222, and the event detection pixel received light amount calculation section 223.

A signal processing device 101E in FIG. 25 is constituted of a hybrid EVS sensor 201E, a subsequent-stage ISP/AP 241E, and the subsequent-stage application 114.

The hybrid EVS sensor 201E has the same basic functions as those of the hybrid EVS sensor 201, but is provided with an event data acquisition section 221E, a gradation signal acquisition section 222E, and an event detection pixel received light amount calculation section 223E having the same functions as those of the event data acquisition section 221, the gradation signal acquisition section 222, and the event detection pixel received light amount calculation section 223, respectively.

The subsequent-stage ISP/AP 241E is provided with a latency correction section 224E having the same functions as those of the latency correction section 224.

That is, in the signal processing device 101E in FIG. 25, the functions of the hybrid EVS sensor 201 in FIG. 23 are realized by the hybrid EVS sensor 201E and the subsequent-stage ISP/AP 241E. With such a configuration, the signal processing device 101E in FIG. 25 also substantially realizes the functions of the signal processing device 101A in FIG. 11 or the signal processing device 101B in FIG. 19.

### 6. Fifth Embodiment

In the above, a configuration example of the signal processing device that uses the hybrid EVS sensor 201 has been described. However, the gradation signal and the event data may be switched and acquired from the pixel signal of the pixel array constituting the CMOS image sensor 151.

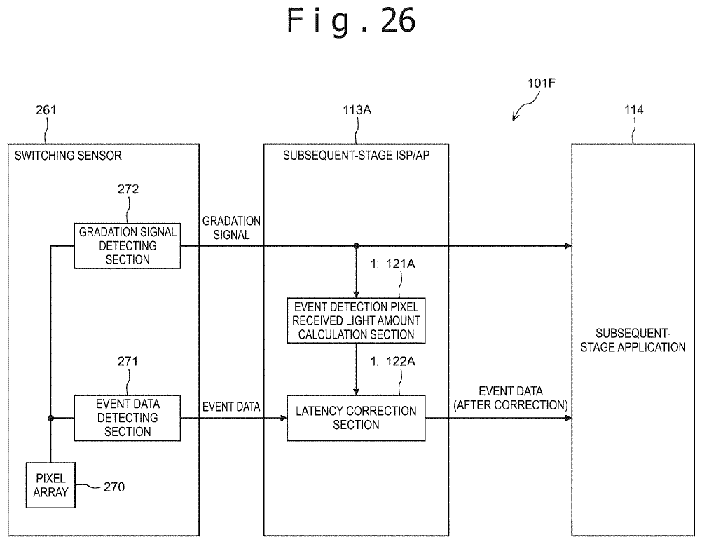

FIG. 26 depicts a configuration example of a signal processing device that switches between acquiring the gradation signal and acquiring the event data from the pixel signal of the pixel array constituting the CMOS image sensor 151.

A signal processing device 101F in FIG. 26 includes a switching sensor 261, the subsequent-stage ISP/AP 113A, and the subsequent-stage application 114.

The switching sensor 261 includes a pixel array 270 constituting the CMOS image sensor 151, an event data detecting section 271 that acquires the event data on the basis of a signal output from the pixel array 270, and a gradation signal detecting section 272 that detects a gradation signal.

The signal output from the pixel array 270 is switched between being output to only the event data detecting section 271 and being output to only the gradation signal detecting section 272.

Therefore, the event data detecting section 271 detects event data at a timing when a signal is output from the pixel array 270 to itself, and outputs the event data to the latency correction section 122A of the subsequent-stage ISP/AP 113.

Further, the gradation signal detecting section 272 detects a gradation signal at a timing when a signal is output from the pixel array 270 to itself, and outputs the gradation signal to the event detection pixel received light amount calculation section 121A of the subsequent-stage ISP/AP 113.

That is, the switching sensor 261 functions as a configuration having both the functions of the CMOS image sensor 151 and the event signal detection sensor 111 described above.

As a result, with such a configuration, the signal processing device 101F in FIG. 26 also substantially realizes the functions of the signal processing device 101A in FIG. 11 or the signal processing device 101B in FIG. 19.

### 7. Application Example

In the above, an example has been described in which the latency correction amount is set in accordance with the received light amount, and the time stamp that is the time information in the event data is corrected by the latency correction amount, thereby correcting the event data.

However, in a case in which the event data is transmitted to the subsequent-stage application 114 in units of event data groups, each consisting of a plurality of event data, an event data group configured to be shifted by the latency correction amount specified in accordance with the received light amount may be output to the subsequent-stage application 114.

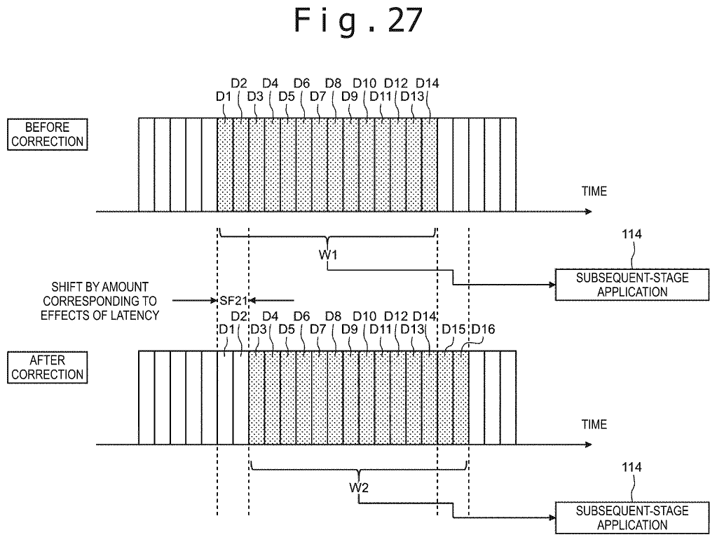

More specifically, as depicted in the upper portion in FIG. 27, each strip-shaped frame represents a single event data item, the data is assumed to be generated sequentially in the right direction in the drawing, and the effects of latency are assumed to occur for a duration equivalent to two event data items.

Here, in the upper portion in FIG. 27, a case is considered in which, after a predetermined quantity of event data items generated in time series is sequentially buffered, an event data group W1 consisting of event data D1 to D14 is output to the subsequent-stage application 114, for example.

In this case, when the event data group W1 is transmitted to the subsequent-stage application 114 as is, the subsequent-stage application 114 processes, as is, the event data D1 and D2, which are already past event data, at the timing of acquisition of the event data, resulting in the occurrence of the effects of the latency.

Therefore, when transmitting the event data group, the latency correction section 122 of the subsequent-stage ISP/AP 113 may shift the event data group by a latency correction amount SF21, skipping the two pieces of event data D1 and D2 expected to be affected by the latency, and transmit an event data group W2 consisting of the subsequent-stage event data D3 to D16 to the subsequent-stage application 114, as depicted in the lower portion in FIG. 27.

By this processing, the event data group is shifted and transmitted in a state in which the past event data is skipped by an amount corresponding to the latency. Accordingly, when the subsequent-stage application 114 acquires the event data group W2, the event data group is acquired as the event data group W2 from which the effects of latency have been removed, and thus processing in which the effects of the latency are corrected is realized by simply processing the event data constituting the acquired event data group W2 sequentially in time series.

### Signal Processing in Application Example

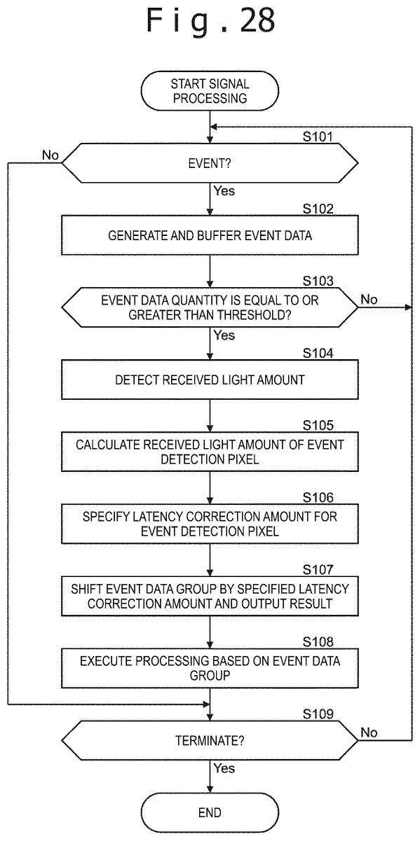

Next, the signal processing in the application example will be described with reference to a flowchart in FIG. 28. Note that, here, the processing in a case in which the signal processing with reference to FIG. 27 is performed by the signal processing device 101 in FIG. 7 will be described, and the assumption is made that all pixels have the same received light amount and the event data of all pixels is corrected by a unified latency correction amount.

In step S101, the event signal detection sensor 111 determines whether an event has been detected. In a case in which the determination is made in step S101 that an event has been detected, the processing proceeds to step S102.

In step S102, the event signal detection sensor 111 outputs the event data to the latency correction section 122 of the subsequent-stage ISP/AP 113. At this time, the latency correction section 122 buffers the event data.

In step S103, the event signal detection sensor 111 determines whether the buffered event data quantity is equal to or greater than a predetermined threshold, and, in a case in which the quantity is not equal to or greater than the predetermined threshold, the processing returns to step S101.

Note that the predetermined threshold here is, for example, a value obtained by adding the quantity of event data items corresponding to the assumed latency to the quantity of event data items transmitted as the event data group described with reference to FIG. 27.

Accordingly, in the example in FIG. 27, because the latency involves two event data items, the predetermined threshold is 16 or greater.

In step S103, in a case in which the determination is made that the buffered event data quantity is equal to or greater than the predetermined threshold, the processing proceeds to step S104.

In step S104, the visible light sensor 112 outputs a sensor output signal corresponding to the received light amount of visible light to the event detection pixel received light amount calculation section 121 of the subsequent-stage ISP/AP 113.

In step S105, the event detection pixel received light amount calculation section 121 calculates the received light amount per unit time of the event detection pixels constituting the event signal detection sensor 111 on the basis of the sensor output signal corresponding to the received light amount of the visible light, and outputs the received light amount that is the calculation result to the latency correction section 122.

In step S106, the latency correction section 122 reads out the latency registered in association with the received light amount from the stored table, and specifies the latency correction amount by performing interpolation or the like, as necessary.

In step S107, the latency correction section 122 shifts, in the buffered event data, event data by an amount corresponding to the latency correction amount, and then forms an event data group consisting of a predetermined quantity of event data items, thereby correcting the latency, and outputs the event data group to the subsequent-stage application 114.

In step S108, the subsequent-stage application 114 sequentially processes the event data constituting the event data group on the basis of the event data group in which the latency is corrected, thereby executing the signal processing, and outputs the execution result.

Further, in a case in which an event has not been detected in step S101, the processing of steps S102 to S108 is skipped.

In step S109, the determination is made as to whether termination of the processing has been instructed, and, in a case in which termination has not been instructed, the processing returns to step S101, and the subsequent processing is repeated.

Then, in step S109, in a case in which termination of the processing has been instructed, the processing ends.

With the above processing, the latency correction amount is specified in accordance with the received light amount, and the event data group is configured to be shifted by the specified latency correction amount, making it possible to realize, in the subsequent-stage application 114, processing in which the effects of latency are corrected by simply sequentially processing the event data constituting the acquired event data group in time series.

As a result, it is possible to appropriately reduce the effects of latency that changes in accordance with the received light amount.

Note that, in the above, the processing in a case in which the signal processing referenced in FIG. 27 is performed by the signal processing device 101 in FIG. 7 has been described. However, similar processing can be realized in units of pixels in any of the signal processing device 101A in FIG. 11, the signal processing device 101C in FIG. 23, the signal processing device 101D in FIG. 24, the signal processing device 101E in FIG. 25, and the signal processing device 101F in FIG. 26.

### First Modification of Event Data Shift Method

In the above, an example has been described in which, among buffered event data, an event data group to be transmitted is shifted by the latency correction amount and output to the subsequent-stage application 114.

However, the possibility exists that the processing may be affected by the loss of event data D1 and D2 that were set not to be transmitted, such as when a need arises to make reference thereto.

Therefore, for the initial event data group, the event data of the subsequent stage may be increased by the latency correction amount, and may be output to the subsequent-stage application 114.

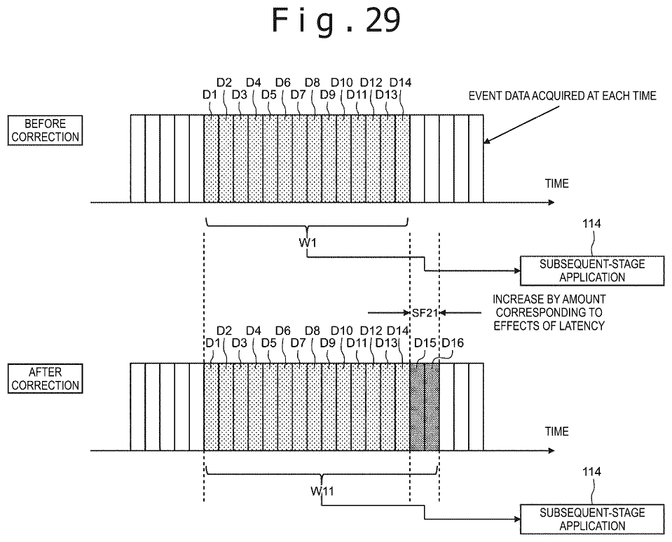

That is, for the event data D1 to D14 of the event data group W1 initially intended to be transmitted to the subsequent-stage application 114 as depicted in the upper portion in FIG. 29, an event data group W11 consisting of the event data D1 to D16 obtained by adding the event data D15 and D16 of a subsequent stage corresponding to the effect of the latency is configured to be transmitted as depicted in the lower portion in FIG. 29.

Then, the subsequent-stage application 114 may execute processing by selectively using the event data D3 to D16 that excludes, from the event data group consisting of the event data D1 to D16, the past event data D1 and D2 that are in the past by an amount of time corresponding to the latency.

That is, as depicted in the lower portion in FIG. 29, the event data group W11, obtained by increasing the event data group W1 consisting of the event data D1 to D14 before correction by the event data D15 and S16 equivalent to the shift amount SF21 corresponding to the portion affected by the latency, is transmitted.

In this case, the subsequent-stage application 114 can recognize, among the event data at the head of the event data group W11, the event data D1 and D2 corresponding to the portion affected by the latency as past event data from the time stamps or the like, and thus executes processing while excluding this event data from the processing in advance, making it possible to realize processing not affected by the latency.

Further, as described above, in a case in which reference needs to be made to the past event data D1 and D2 in accordance with processing contents or the like, the event data is transmitted as an event data group without loss, and thus can be referenced by the subsequent-stage application 114.

### Second Modification of Event Data Shift Method

The event data group may be configured by deleting only the past event data affected by the latency.

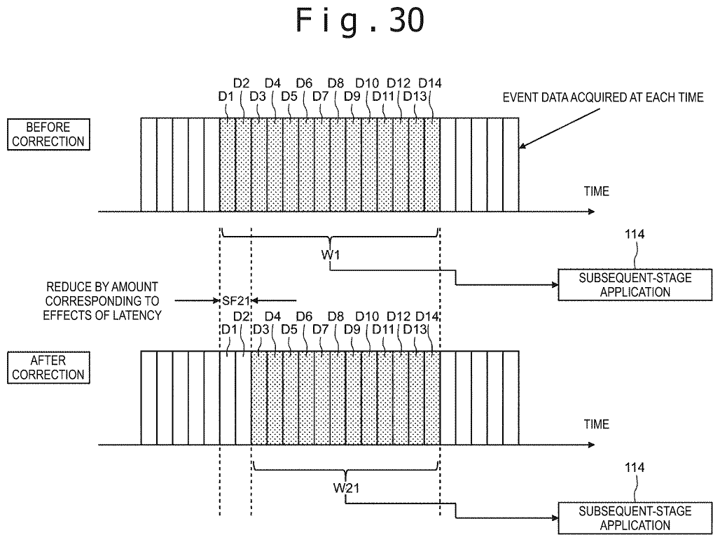

That is, as depicted in the lower portion in FIG. 30, an event data group W21, obtained by deleting, from the event data group W1 before correction depicted in the upper portion in FIG. 30, only the event data D1 and D2 equivalent to the shift amount SF21 corresponding to the portion affected by the latency, is transmitted.

In this case, the subsequent-stage application 114 sequentially executes processing from the event data at the head of the event data group W21, making it possible to realize processing not affected by the latency. In this case, although loss occurs in the chronologically later event data relative to the initial event data group W11, only the event data corresponding to the latency amount is lost, minimizing the effect.

### 8. Application Example of Mobile Body

The technology according to the present disclosure (present technology) can be applied to various products. For example, the technology according to the present disclosure may be realized as a device mounted on any type of mobile body such as an automobile, an electric vehicle, a hybrid electric vehicle, a motorcycle, a bicycle, a personal mobility, an airplane, a drone, a ship, and a robot.

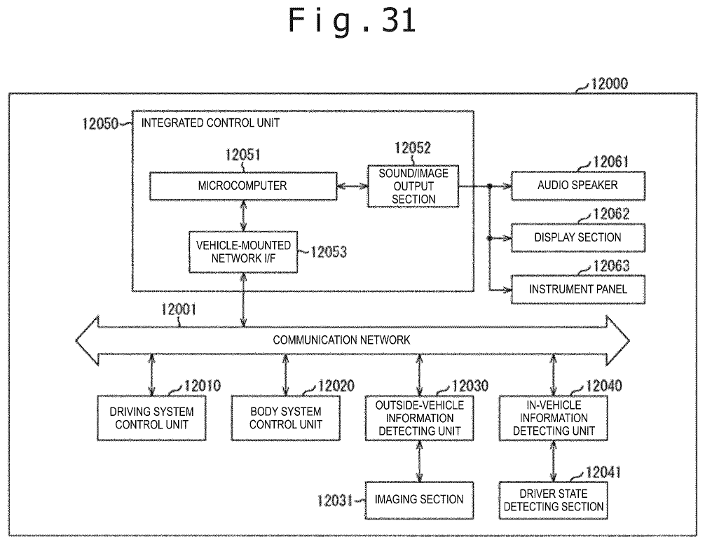

FIG. 31 is a block diagram depicting an example of a schematic configuration of a vehicle control system as an example of a mobile body control system to which the technology according to an embodiment of the present disclosure can be applied.

The vehicle control system 12000 includes a plurality of electronic control units connected to each other via a communication network 12001. In the example depicted in FIG. 31, the vehicle control system 12000 includes a driving system control unit 12010, a body system control unit 12020, an outside-vehicle information detecting unit 12030, an in-vehicle information detecting unit 12040, and an integrated control unit 12050. In addition, a microcomputer 12051, a sound/image output section 12052, and a vehicle-mounted network interface (I/F) 12053 are illustrated as a functional configuration of the integrated control unit 12050.

The driving system control unit 12010 controls the operation of devices related to the driving system of the vehicle in accordance with various kinds of programs. For example, the driving system control unit 12010 functions as a control device for a driving force generating device for generating the driving force of the vehicle, such as an internal combustion engine, a driving motor, or the like, a driving force transmitting mechanism for transmitting the driving force to wheels, a steering mechanism for adjusting the steering angle of the vehicle, a braking device for generating the braking force of the vehicle, and the like.

The body system control unit 12020 controls the operation of various kinds of devices provided to a vehicle body in accordance with various kinds of programs. For example, the body system control unit 12020 functions as a control device for a keyless entry system, a smart key system, a power window device, or various kinds of lamps such as a headlamp, a backup lamp, a brake lamp, a turn signal, a fog lamp, or the like. In this case, radio waves transmitted from a mobile device as an alternative to a key or signals of various kinds of switches can be input to the body system control unit 12020. The body system control unit 12020 receives these input radio waves or signals, and controls a door lock device, the power window device, the lamps, or the like of the vehicle.

The outside-vehicle information detecting unit 12030 detects information about the outside of the vehicle including the vehicle control system 12000. For example, the outside-vehicle information detecting unit 12030 is connected with an imaging section 12031. The outside-vehicle information detecting unit 12030 makes the imaging section 12031 image an image of the outside of the vehicle, and receives the imaged image. On the basis of the received image, the outside-vehicle information detecting unit 12030 may perform processing of detecting an object such as a human, a vehicle, an obstacle, a sign, a character on a road surface, or the like, or processing of detecting a distance thereto.

The imaging section 12031 is an optical sensor that receives light, and which outputs an electric signal corresponding to a received light amount of the light. The imaging section 12031 can output the electric signal as an image, or can output the electric signal as information about a measured distance. In addition, the light received by the imaging section 12031 may be visible light, or may be invisible light such as infrared rays or the like.

The in-vehicle information detecting unit 12040 detects information about the inside of the vehicle. The in-vehicle information detecting unit 12040 is, for example, connected with a driver state detecting section 12041 that detects the state of a driver. The driver state detecting section 12041, for example, includes a camera that images the driver. On the basis of detection information input from the driver state detecting section 12041, the in-vehicle information detecting unit 12040 may calculate a degree of fatigue of the driver or a degree of concentration of the driver, or may determine whether the driver is dozing.

The microcomputer 12051 can calculate a control target value for the driving force generating device, the steering mechanism, or the braking device on the basis of the information about the inside or outside of the vehicle which is obtained by the outside-vehicle information detecting unit 12030 or the in-vehicle information detecting unit 12040, and output a control command to the driving system control unit 12010. For example, the microcomputer 12051 can perform cooperative control intended to implement functions of an advanced driver assistance system (ADAS) which functions include collision avoidance or shock mitigation for the vehicle, following driving based on a following distance, vehicle speed maintaining driving, a warning of collision of the vehicle, a warning of deviation of the vehicle from a lane, or the like.

In addition, the microcomputer 12051 can perform cooperative control intended for automated driving, which makes the vehicle travel automatedly without depending on the operation of the driver, or the like, by controlling the driving force generating device, the steering mechanism, the braking device, or the like on the basis of the information about the outside or inside of the vehicle which is obtained by the outside-vehicle information detecting unit 12030 or the in-vehicle information detecting unit 12040.

In addition, the microcomputer 12051 can output a control command to the body system control unit 12030 on the basis of the information about the outside of the vehicle which is obtained by the outside-vehicle information detecting unit 12030. For example, the microcomputer 12051 can perform cooperative control intended to prevent a glare by controlling the headlamp so as to change from a high beam to a low beam, for example, in accordance with the position of a preceding vehicle or an oncoming vehicle detected by the outside-vehicle information detecting unit 12030.

The sound/image output section 12052 transmits an output signal of at least one of a sound and an image to an output device capable of visually or auditorily notifying information to an occupant of the vehicle or the outside of the vehicle. In the example of FIG. 31, an audio speaker 12061, a display section 12062, and an instrument panel 12063 are illustrated as the output device. The display section 12062 may, for example, include at least one of an on-board display and a head-up display.

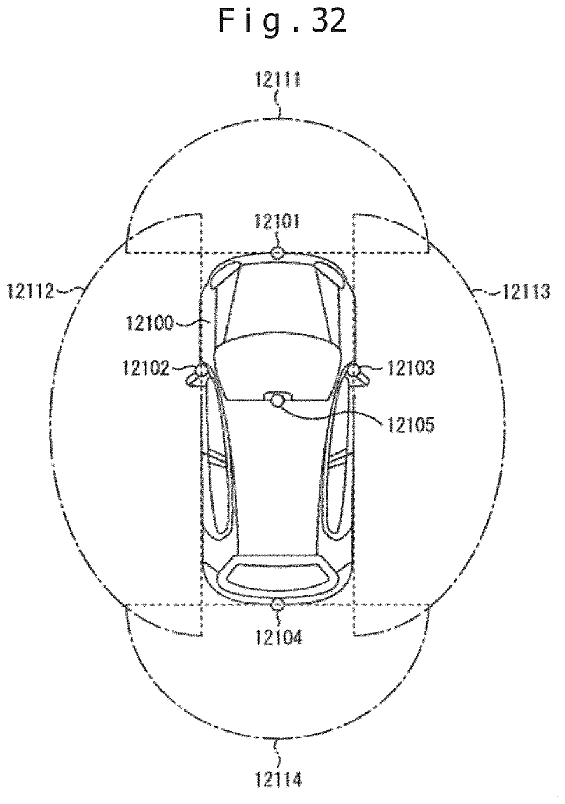

FIG. 32 is a diagram depicting an example of the installation position of the imaging section 12031.

In FIG. 32, the imaging section 12031 includes imaging sections 12101, 12102, 12103, 12104, and 12105.

The imaging sections 12101, 12102, 12103, 12104, and 12105 are, for example, disposed at positions on a front nose, sideview mirrors, a rear bumper, and a back door of the vehicle 12100 as well as a position on an upper portion of a windshield within the interior of the vehicle. The imaging section 12101 provided to the front nose and the imaging section 12105 provided to the upper portion of the windshield within the interior of the vehicle obtain mainly an image of the front of the vehicle 12100. The imaging sections 12102 and 12103 provided to the sideview mirrors obtain mainly an image of the sides of the vehicle 12100. The imaging section 12104 provided to the rear bumper or the back door obtains mainly an image of the rear of the vehicle 12100. The imaging section 12105 provided to the upper portion of the windshield within the interior of the vehicle is used mainly to detect a preceding vehicle, a pedestrian, an obstacle, a signal, a traffic sign, a lane, or the like.

Incidentally, FIG. 32 depicts an example of photographing ranges of the imaging sections 12101 to 12104. An imaging range 12111 represents the imaging range of the imaging section 12101 provided to the front nose. Imaging ranges 12112 and 12113 respectively represent the imaging ranges of the imaging sections 12102 and 12103 provided to the sideview mirrors. An imaging range 12114 represents the imaging range of the imaging section 12104 provided to the rear bumper or the back door. A bird's-eye image of the vehicle 12100 as viewed from above is obtained by superimposing image data imaged by the imaging sections 12101 to 12104, for example.

At least one of the imaging sections 12101 to 12104 may have a function of obtaining distance information. For example, at least one of the imaging sections 12101 to 12104 may be a stereo camera constituted of a plurality of imaging elements, or may be an imaging element having pixels for phase difference detection.

For example, the microcomputer 12051 can determine a distance to each three-dimensional object within the imaging ranges 12111 to 12114 and a temporal change in the distance (relative speed with respect to the vehicle 12100) on the basis of the distance information obtained from the imaging sections 12101 to 12104, and thereby extract, as a preceding vehicle, a nearest three-dimensional object in particular that is present on a traveling path of the vehicle 12100 and which travels in substantially the same direction as the vehicle 12100 at a predetermined speed (for example, equal to or more than 0 km/hour). Further, the microcomputer 12051 can set a following distance to be maintained in front of a preceding vehicle in advance, and perform automatic brake control (including following stop control), automatic acceleration control (including following start control), or the like. It is thus possible to perform cooperative control intended for automated driving that makes the vehicle travel automatedly without depending on the operation of the driver or the like.

For example, the microcomputer 12051 can classify three-dimensional object data on three-dimensional objects into three-dimensional object data of a two-wheeled vehicle, a standard-sized vehicle, a large-sized vehicle, a pedestrian, a utility pole, and other three-dimensional objects on the basis of the distance information obtained from the imaging sections 12101 to 12104, extract the classified three-dimensional object data, and use the extracted three-dimensional object data for automatic avoidance of an obstacle. For example, the microcomputer 12051 identifies obstacles around the vehicle 12100 as obstacles that the driver of the vehicle 12100 can recognize visually and obstacles that are difficult for the driver of the vehicle 12100 to recognize visually. Then, the microcomputer 12051 determines a collision risk indicating a risk of collision with each obstacle. In a situation in which the collision risk is equal to or higher than a set value and there is thus a possibility of collision, the microcomputer 12051 outputs a warning to the driver via the audio speaker 12061 or the display section 12062, and performs forced deceleration or avoidance steering via the driving system control unit 12010. The microcomputer 12051 can thereby assist in driving to avoid collision.

At least one of the imaging sections 12101 to 12104 may be an infrared camera that detects infrared rays. The microcomputer 12051 can, for example, recognize a pedestrian by determining whether or not there is a pedestrian in imaged images of the imaging sections 12101 to 12104. Such recognition of a pedestrian is, for example, performed by a procedure of extracting characteristic points in the imaged images of the imaging sections 12101 to 12104 as infrared cameras and a procedure of determining whether or not it is the pedestrian by performing pattern matching processing on a series of characteristic points representing the contour of the object. When the microcomputer 12051 determines that there is a pedestrian in the imaged images of the imaging sections 12101 to 12104, and thus recognizes the pedestrian, the sound/image output section 12052 controls the display section 12062 so that a square contour line for emphasis is displayed so as to be superimposed on the recognized pedestrian. The sound/image output section 12052 may also control the display section 12062 so that an icon or the like representing the pedestrian is displayed at a desired position.

An example of the vehicle control system to which the technology according to the present disclosure can be applied has been described above. The technology according to the present disclosure can be applied to a configuration obtained by combining the imaging section 12031 and the outside-vehicle information detecting unit 12030 among the configurations described above. Specifically, the signal processing device 101 of FIG. 7, the signal processing device 101A of FIG. 11, the signal processing device 101B of FIG. 19, the signal processing device 101C of FIG. 23, the signal processing device 101D of FIG. 24, the signal processing device 101E of FIG. 25, and the signal processing device 101F of FIG. 26 can be applied to a configuration obtained by combining the imaging section 12031 and the outside-vehicle information detecting unit 12030. By applying the technology according to the present disclosure to a configuration obtained by combining the imaging section 12031 and the outside-vehicle information detecting unit 12030, it is possible to reduce the effects of latency that may occur in the processing of detecting an object or the processing of detecting the distance thereto.

Note that, in the present specification, a system refers to a collection of a plurality of constituent elements (devices, modules (parts), and the like), and it does not matter whether all the constituent elements are in the same housing. Accordingly, both a plurality of devices accommodated in separate housings and connected together via a network and a single device in which a plurality of modules are accommodated in one housing are systems.

Further, embodiments of the present disclosure are not limited to the embodiments described above, and various changes can be made thereto without departing from the spirit and scope of the present disclosure.

For example, the present disclosure may take a form of cloud computing in which one function is shared and performed together by a plurality of devices via a network.

Further, the steps described with reference to the flowcharts described above may be executed by a single device or may be executed by a plurality of devices in a shared manner.

Furthermore, in a case in which a single step includes a plurality of processes, the plurality of processes included in the single step may be executed by a single device or may be executed by a plurality of devices in a shared manner.

Note that the present disclosure can also adopt configurations such as the following.
(1) A light detection device including:
an event detecting section configured to output event data representing occurrence of an event that is a change in an electric signal, the event being detected in an event detection pixel configured to generate the electric signal by performing photoelectric conversion, and a plurality of the event detection pixels being disposed on a two-dimensional plane;
a received light amount calculation section configured to calculate a received light amount of the event detection pixel; and
a latency correction section configured to correct information related to latency in the event data on the basis of the received light amount of the event detection pixel calculated by the received light amount calculation section.
(2) The light detection device according to (1),
wherein the latency correction section includes a table registering a relationship between the received light amount and the latency, reads out, from the table, the latency corresponding to the received light amount calculated by the received light amount calculation section, and corrects the event data by a latency correction amount consisting of the readout latency.
(3) The light detection device according to (2),
wherein the event data includes time information indicating when the event is detected by the event detecting section, and
the latency correction section corrects the time information about the event data by the latency correction amount corresponding to the received light amount.
(4) The light detection device according to (3),
wherein the event data further includes coordinate information indicating a pixel position of each of the plurality of event detection pixels of the event detecting section, and
the latency correction section corrects, in association with the coordinate information about each of the plurality of event detection pixels, the time information about the event data by the latency correction amount corresponding to the received light amount.
(5) The light detection device according to (3),
wherein the event data further includes coordinate information indicating a pixel position of each of the plurality of event detection pixels of the event detecting section, and
the latency correction section corrects the event data by adding corrected time information obtained by correcting the time information by the latency correction amount corresponding to the received light amount or by adding the latency correction amount, in association with the coordinate information about each of the plurality of event detection pixels.
(6) The light detection device according to (3),
wherein the event data further includes information about a type of the event indicating whether the event is a positive event in which the electric signal detected by the event detecting section changes in a positive direction or a negative event in which the electric signal changes in a negative direction,
the table registers a relationship between the received light amount and the latency for each information item about the type of the event, and
the latency correction section corrects the event data by adding corrected time information obtained by correcting the time information by the latency correction amount corresponding to the received light amount or by adding the latency correction amount, in accordance with the type of the event and in association with the coordinate position of each of the plurality of event detection pixels.
(7) The light detection device according to (1), further including:
a visible light detecting section configured to detect the received light amount of visible light in a vicinity of an imaging surface configured by disposing the plurality of event detection pixels on a two-dimensional plane and output an output signal corresponding to the received light amount that is detected,
wherein the received light amount calculation section calculates the received light amount of the event detection pixel on the basis of the output signal.
(8) The light detection device according to (7),
wherein the visible light detecting section detects the received light amount of the visible light at one point in the vicinity of the imaging surface configured by disposing the plurality of event detection pixels on the two-dimensional plane and outputs the received light amount of the visible light as the corresponding output signal,
the received light amount calculation section calculates the received light amount of each of all the event detection pixels as the same received light amount on the basis of the output signal, and
the latency correction section corrects the event data of each of all the event detection pixels by a latency correction amount corresponding to the same received light amount.
(9) The light detection device according to (1), further including:
a gradation signal detecting section including, in a vicinity of an imaging surface configured by disposing the plurality of event detection pixels on the two-dimensional plane, a plurality of imaging pixels disposed on a two-dimensional plane and configured to detect and output a gradation signal corresponding to a light amount of incident light,
wherein the received light amount calculation section calculates the received light amount of each of the plurality of event detection pixels on the basis of the gradation signal of each of the plurality of imaging pixels.
(10) The light detection device according to (9),
wherein the received light amount calculation section calculates the received light amount for each of the plurality of imaging pixels, and applies the calculated received light amount as the received light amount of the event detection pixel at a position corresponding to a position of the imaging pixel, and
the latency correction section corrects the event data of each of the plurality of event detection pixels by a latency correction amount corresponding to the received light amount applied to each of the plurality of event detection pixels.
(11) The light detection device according to (10),
wherein the received light amount calculation section calculates the received light amount of the event detection pixel on the basis of a predetermined spectrum and the gradation signal.
(12) The light detection device according to (11),
wherein the predetermined spectrum is a spectrum estimated from the gradation signal.
(13) The light detection device according to (12),
wherein the plurality of imaging pixels constituting the gradation signal detecting section are provided with a plurality of filters configured to perform filtering such that the transmitted incident light is divided into a plurality of wavelength bands, the plurality of filters being provided in a predetermined array at preceding stages of the plurality of imaging pixels and for each of the plurality of imaging pixels, and
the received light amount calculation section estimates the spectrum from a ratio of the received light amount based on the gradation signal for each of the plurality of filters, and calculates the received light amount of the event detection pixel on the basis of the estimated spectrum and the gradation signal.
(14) The light detection device according to (9),
wherein the received light amount calculation section calculates the received light amount for each of the plurality of imaging pixels and applies the calculated received light amount as the received light amount of the event detection pixel at a position corresponding to a position of the imaging pixel, and
the latency correction section corrects the event data of each of the plurality of event detection pixels by adding the received light amount applied to each of the plurality of event detection pixels to the event data.
(15) The light detection device according to (9),
wherein the plurality of event detection pixels and the plurality of imaging pixels are disposed on the same two-dimensional plane, and
the event detecting section and the gradation signal detecting section are integrated.
(16) The light detection device according to (15),
wherein the received light amount calculation section is integrated in addition to the event detecting section and the gradation signal detecting section.
(17) The light detection device according to (16),
wherein the latency correction section is integrated in addition to the event detecting section, the gradation signal detecting section, and the received light amount calculation section.
(18) The light detection device according to (1),
wherein the latency correction section corrects the information related to the latency of the event data by shifting, on the basis of the received light amount of each of the plurality of event detection pixels calculated by the received light amount calculation section, an event data group consisting of a predetermined quantity of the time-series event data to be output to a subsequent stage, by an event data quantity corresponding to the latency, and outputting the shifted event data.
(19) A light detection method including:
outputting event data representing occurrence of an event that is a change in an electric signal, the event being detected in an event detection pixel configured to generate the electric signal by performing photoelectric conversion, a plurality of the event detection pixels being disposed on a two-dimensional plane;
calculating a received light amount of the event detection pixel; and
correcting information related to latency in the event data on the basis of the calculated received light amount of the event detection pixel.
(20) A program that causes a computer to function as:
an event detecting section configured to output event data representing occurrence of an event that is a change in an electric signal, the event being detected in an event detection pixel configured to generate the electric signal by performing photoelectric conversion, a plurality of the event detection pixels being disposed on a two-dimensional plane;
a received light amount calculation section configured to calculate a received light amount of the event detection pixel; and
a latency correction section configured to correct information related to latency in the event data on the basis of the received light amount of the event detection pixel calculated by the received light amount calculation section.

### REFERENCE SIGNS LIST

101, 101A to 101F Signal processing device, 111 Event signal detection sensor, 112 Visible light sensor, 113, 113A, 113B Subsequent-stage ISP/AP, 114, 114B Subsequent-stage application, 121, 121A, 121B Event detection pixel received light amount calculation section, 122, 122A, 122B Latency correction section, 141, 141A-1, 141A-2, 141B Lens, 151 CMOS image sensor, 171 Latency correction section, 201, 201D, 201E Hybrid EVS sensor, 221, 221D, 221E Event data acquisition section, 222, 222D, 222E Gradation signal acquisition section, 223, 223D, 223E Event detection pixel received light amount calculation section, 224, 224D, 224E Latency correction section, 241, 241E Subsequent-stage ISP/AP, 261 Switching sensor, 270 Pixel array, 271 Event data detecting section, 272 Gradation signal acquisition section

1. A light detection device comprising:
an event detecting section configured to output event data representing occurrence of an event that is a change in an electric signal, the event being detected in an event detection pixel configured to generate the electric signal by performing photoelectric conversion, a plurality of the event detection pixels being disposed on a two-dimensional plane;
a received light amount calculation section configured to calculate a received light amount of the event detection pixel; and
a latency correction section configured to correct information related to latency in the event data on the basis of the received light amount of the event detection pixel calculated by the received light amount calculation section.

2. The light detection device according to claim 1,
wherein the latency correction section includes a table registering a relationship between the received light amount and the latency, reads out, from the table, the latency corresponding to the received light amount calculated by the received light amount calculation section, and corrects the event data by a latency correction amount consisting of the readout latency.

3. The light detection device according to claim 2,
wherein the event data includes time information indicating when the event is detected by the event detecting section, and
the latency correction section corrects the time information about the event data by the latency correction amount corresponding to the received light amount.

4. The light detection device according to claim 3,
wherein the event data further includes coordinate information indicating a pixel position of each of the plurality of event detection pixels of the event detecting section, and
the latency correction section corrects, in association with coordinate information about each of the plurality of event detection pixels, the time information about the event data by the latency correction amount corresponding to the received light amount.

5. The light detection device according to claim 3,
wherein the event data further includes coordinate information indicating a pixel position of each of the plurality of event detection pixels of the event detecting section, and
the latency correction section corrects the event data by adding corrected time information obtained by correcting the time information by the latency correction amount corresponding to the received light amount or by adding the latency correction amount, in association with the coordinate information about each of the plurality of event detection pixels.

6. The light detection device according to claim 3,
wherein the event data further includes information about a type of the event indicating whether the event is a positive event in which the electric signal detected by the event detecting section changes in a positive direction or a negative event in which the electric signal changes in a negative direction,
the table registers a relationship between the received light amount and the latency for each information item about the type of the event, and
the latency correction section corrects the event data by adding corrected time information obtained by correcting the time information by the latency correction amount corresponding to the received light amount or by adding the latency correction amount, in accordance with the type of the event and in association with the coordinate position of each of the plurality of event detection pixels.

7. The light detection device according to claim 1, further comprising:
a visible light detecting section configured to detect the received light amount of visible light in a vicinity of an imaging surface configured by disposing the plurality of event detection pixels on a two-dimensional plane and output an output signal corresponding to the received light amount that is detected,
wherein the received light amount calculation section calculates the received light amount of the event detection pixel on the basis of the output signal.

8. The light detection device according to claim 7,
wherein the visible light detecting section detects the received light amount of the visible light at one point in the vicinity of the imaging surface configured by disposing the plurality of event detection pixels on the two-dimensional plane and outputs the received light amount of the visible light as the corresponding output signal,
the received light amount calculation section calculates the received light amount of each of all the plurality of event detection pixels as the same received light amount on the basis of the output signal, and
the latency correction section corrects the event data of each of all the plurality of event detection pixels by a latency correction amount corresponding to the same received light amount.

9. The light detection device according to claim 1, further comprising:
a gradation signal detecting section including, in a vicinity of an imaging surface configured by disposing the plurality of event detection pixels on the two-dimensional plane, a plurality of imaging pixels disposed on a two-dimensional plane and configured to detect and output a gradation signal corresponding to a light amount of incident light,
wherein the received light amount calculation section calculates the received light amount of each of the plurality of event detection pixels on the basis of the gradation signal of each of the plurality of imaging pixels.

10. The light detection device according to claim 9,
wherein the received light amount calculation section calculates the received light amount for each of the plurality of imaging pixels and applies the calculated received light amount as the received light amount of the event detection pixel at a position corresponding to a position of the imaging pixel, and
the latency correction section corrects the event data of each of the plurality of event detection pixels by a latency correction amount corresponding to the received light amount applied to each of the plurality of event detection pixels.

11. The light detection device according to claim 10,
wherein the received light amount calculation section calculates the received light amount of the event detection pixel on the basis of a predetermined spectrum and the gradation signal.

12. The light detection device according to claim 11,
wherein the predetermined spectrum is a spectrum estimated from the gradation signal.

13. The light detection device according to claim 12,
wherein the plurality of imaging pixels constituting the gradation signal detecting section are provided with a plurality of filters configured to perform filtering such that the transmitted incident light is divided into a plurality of wavelength bands, the plurality of filters being provided in a predetermined array at preceding stages of the plurality of imaging pixels and for each of the plurality of imaging pixels, and
the received light amount calculation section estimates the spectrum from a ratio of the received light amount based on the gradation signal for each of the plurality of filters, and calculates the received light amount of the event detection pixel on the basis of the estimated spectrum and the gradation signal.

14. The light detection device according to claim 9,
wherein the received light amount calculation section calculates the received light amount for each of the plurality of imaging pixels and applies the calculated received light amount as the received light amount of the event detection pixel at a position corresponding to a position of the imaging pixel, and
the latency correction section corrects the event data of each of the plurality of event detection pixels by adding the received light amount applied to each of the plurality of event detection pixels to the event data.

15. The light detection device according to claim 9,
wherein the plurality of event detection pixels and the plurality of imaging pixels are disposed on the same two-dimensional plane, and
the event detecting section and the gradation signal detecting section are integrated.

16. The light detection device according to claim 15,
wherein the received light amount calculation section is integrated in addition to the event detecting section and the gradation signal detecting section.

17. The light detection device according to claim 16,
wherein the latency correction section is integrated in addition to the event detecting section, the gradation signal detecting section, and the received light amount calculation section.

18. The light detection device according to claim 1,
wherein the latency correction section corrects the information related to the latency of the event data by shifting, on the basis of the received light amount of the event detection pixel calculated by the received light amount calculation section, an event data group consisting of a predetermined quantity of the time-series event data to be output to a subsequent stage, by an event data quantity corresponding to the latency, and outputting the shifted event data group.

19. A light detection method comprising:
outputting event data representing occurrence of an event that is a change in an electric signal, the event being detected in an event detection pixel configured to generate the electric signal by performing photoelectric conversion, a plurality of the event detection pixels being disposed on a two-dimensional plane;
calculating a received light amount of the event detection pixel; and
correcting information related to latency in the event data on the basis of the calculated received light amount of the event detection pixels.

20. A program that causes a computer to function as:
an event detecting section configured to output event data representing occurrence of an event that is a change in an electric signal, the event being detected in an event detection pixel configured to generate the electric signal by performing photoelectric conversion, a plurality of the event detection pixels being disposed on a two-dimensional plane;
a received light amount calculation section configured to calculate a received light amount of the event detection pixel; and
a latency correction section configured to correct information related to latency in the event data on the basis of the received light amount of the event detection pixel calculated by the received light amount calculation section.
